(19) United States
(12) Patent Application Publication
(10) Pub. No.: US 2026/0265127 A1
(43) Pub. Date: Sep. 10, 2026

(54) COMPOSITIONS OF CONTROLLED CRYSTAL GROWTHS AND METHODS OF PRODUCING THE SAME

(71) Applicant: Biomason Inc., Durham, NC (US)

(72) Inventors: Ginger K. Dosier, Raleigh, NC (US); John Michael Dosier, Raleigh, NC (US); Kent J. Smith, Hurdle Hills, NC (US); Steven W. McAllister, Durham, NC (US); Bharath Melugiri Shankaramurthy, Cary, NC (US); Betiglu Eshete Jimma, Morrisville, NC (US); Connor Michael Budziszewski, Raleigh, NC (US); Brian S. Chapman, Durham, NC (US)

(21) Appl. No.: 19/160,814

(22) PCT Filed: Mar. 4, 2024
(86) PCT No.: PCT/US2024/018420

§ 371 Date: Aug. 28, 2025

Related U.S. Application Data
(60) Provisional application No. 63/488,397, filed on Mar. 3, 2023.

(51) Int. Cl. C04B 7/345; C04B 20/04; C04B 40/00; C04B 103/00

(52) U.S. Cl. CPC C04B 7/345; C04B 20/04; C04B 40/0032; C04B 2103/0001; C04B 2201/20

(57) ABSTRACT

Described herein are novel construction material compositions, systems, and methods for manufacturing the same. Biocement technologies that monitor and adjust environmental and process controls during the manufacturing of biocement products are described. Construction materials with advantageous properties, such as increased compressive strength, may be manufactured using the biocement technologies. In some cases, the application and adjustment of temperature, pH, and humidity are used to selectively control the rate of biocement formation within different planar sections of a construction material. For example, a planar section of the construction material that includes a non-preferred surface (or a surface to which a cementation solution is applied) may form biocement at a slower rate than other planar sections of the construction material that are at least a threshold distance away from the non-preferred surface.

### CLAIM OF PRIORITY

This application is a 371 of international PCT/US 2024/018420, filed Mar. 4, 2024, which claims the benefit of and priority to U.S. Provisional Application No. 63/488,397, filed Mar. 3, 2023, which is herein incorporated by reference in its entirety.

### BACKGROUND

Biocement technologies offer cost effective high-strength building materials, structural materials, and concretes which can have a substantially reduced carbon emission footprint compared to traditional building materials and concretes. Accordingly, improved biocement compositions and processes may encourage the replacement of traditional building materials and concretes with biocement products.

### BRIEF SUMMARY

Biocement technologies utilize microorganisms to improve the mechanical and structural properties of construction materials. In some cases, through microbiologically induced calcium carbonate precipitation (MICP), microorganisms can react with chemical components to produce minerals in the form of organic-inorganic compounds that act as binding agents within a construction material. In some cases, environmental and process controls may be utilized to ensure that a surface (or a planar section that abuts an external surface) of the construction material that is being fed a cementation solution that includes a cementation reagent (e.g., using a fluid delivery system to apply the cementation solution to the surface of the construction material) forms biocement at a slower rate than other portions or planar sections of the construction material. A technical benefit of reducing the rate of biocement formation within one or more planar sections of the construction material that are near to or abut a surface to which a cementation solution is applied (e.g., a planar section comprising the top 1 cm of the construction material) is that clogging related issues may be reduced, the overall cost to manufacture the construction material may be reduced, the compressive strength of the construction material may be increased, and the manufacturing variability in construction material properties may be reduced.

In some embodiments, the application and adjustment of temperature, pH, and/or humidity during manufacturing of a construction material are used to selectively control the rate of biocement formation within different planar sections of a construction material. In one example, a planar section of the construction material that includes a non-preferred surface (or a surface to which a cementation solution is applied) forms biocement at a slower rate than other planar sections of the construction material that are at least a threshold distance away from the non-preferred surface.

In some embodiments, the temperature of a construction material prior to and during biocementation and the temperature of a feed solution being fed to the construction material may be independently varied during manufacturing of the construction material. In one example, the temperature of the feed solution may be less than the temperature of the construction material during a biocementation process phase. In another example, during a biocementation phase, the temperature of the feed solution may be initially less than the temperature of the construction material during a first period of time and then increased during a second period of time subsequent to the first period of time. In another example, the temperature of the feed solution may be less than the temperature of the construction material during a first period of time and then increased to a temperature greater than the temperature of the construction material during a second period of time subsequent to the first period of time. During the formation of microbial calcite precipitate within the construction material, the temperature of the construction material and the humidity of the environment in which the construction material is situated may be adjusted to improve the resulting compressive strength of the construction material.

In some embodiments, a biocement technology is provided that monitors and adjusts environmental and process controls to ensure that a construction material that is being fed a cementation solution that includes a cementation reagent at a non-preferred surface (or a surface to which the cementation solution is applied) forms biocement at a slower rate for a planar section of the construction material that is near to or abuts the non-preferred surface compared to other planar sections of the construction material that are far from or do not abut the non-preferred surface. In one example, the rate of biocement formation for a planar section comprising the top 1 cm of the construction material is at least 20% to 50% slower than the rate of biocement formation for one or more other planar sections of the construction material (e.g., a planar section comprising the bottom 10 cm of the construction material). The temperatures of the construction material and the cementation solution may be varied during manufacturing of the construction material to reduce the rate of biocement formation for a planar section that is near to or abuts a non-preferred surface.

According to some embodiments, the technical benefits of the compositions of controlled crystal growths and the methods of producing the compositions of controlled crystal growths disclosed herein include reduced manufacturing time, increased construction material throughput, increased flexural strength, and increased compressive strength for the construction material.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Like-numbered elements may refer to common components in the different figures.

FIG. 1A illustrates an example formwork that is used to make construction materials.

FIG. 1B depicts one embodiment of a cross-sectional view of a construction material.

FIG. 1C depicts one embodiment of a cross-sectional view of the construction material shown in FIG. 1B.

FIG. 1D depicts one embodiment of a side view of the construction material shown in FIG. 1B.

FIG. 1E depicts one embodiment of aggregate particles within the construction material of FIG. 1D prior to compression.

FIG. 1F depicts one embodiment of aggregate particles within the construction material of FIG. 1D after compression of the aggregate particles.

FIG. 1G depicts one embodiment of experimental results showing the average compressive strength for a construction material over a range of wet green densities for the construction material.

FIG. 1H depicts one embodiment of a graph showing the percentage of total pore volume vs pore diameter for a construction material.

FIG. 1I depicts one embodiment of experimental results showing the average change in electrical conductivity for a construction material over a range of average dry green densities for the construction material.

FIG. 1J depicts one embodiment of a graph showing the total slice porosity over horizontal slice position from a non-preferred surface of a construction material.

FIG. 1K depicts one embodiment of experimental results showing total open pore porosity vs slice number through a construction material.

FIG. 1L depicts one embodiment of a construction material body that comprises aggregate particles that have been bound together using calcium carbonate.

FIG. 1M depicts one embodiment of experimental results showing compressive strength vs wet density and compressive strength vs dry density for a construction material.

FIG. 1N depicts one embodiment of experimental results showing percentage of calcium carbonate vs wet density and percentage of calcium carbonate vs dry density for a construction material.

FIGS. 2A-2B depict SEM images of a top surface layer of an example construction material. FIG. 2B shows a magnified image of an area within FIG. 2A.

FIGS. 3A-3B depict SEM images of a top middle surface layer of an example construction material. FIG. 3B shows a magnified image of an area within FIG. 3A.

FIGS. 4A-4B depict SEM images of a bottom middle surface layer of an example construction material. FIG. 4B shows a magnified image of an area within FIG. 4A.

FIG. 5A depicts one embodiment of a system for manufacturing a construction material using one or more biocementation processes.

FIG. 5B depicts a flowchart describing one embodiment of a process for producing a construction material.

FIG. 5C depicts a flowchart describing an alternative embodiment of a process for producing a construction material.

FIG. 5D depicts a flowchart describing an alternative embodiment of a process for producing a construction material.

### DETAILED DESCRIPTION

As used herein, the term “construction material” or “construction materials” generally refers to an article which comprises elements or subcomponents that are bound together by linkages (e.g., cement linkages) or bridges of adhesive properties. In some cases, the linkages or bridges within a construction material comprise a binding agent, such as calcium carbonate. Construction materials may comprise individual physical objects of a defined shape that are incorporated into, for example, a building, a structure, or a work.

Some construction materials may comprise biocement products. Examples of biocement products include, but are not limited to, items made from bioconcrete, biocement coated aggregates, and the like. As used herein, the term “biocement” generally refers to any binding agent that can be generated through a biological mechanism (e.g., an enzymatic process) which adheres to or encapsulates particles of solid material (e.g., aggregate particles). The binding agent may directly connect two or more aggregate particles, or may indirectly connect two or more aggregate particles via one or more linkages or bridges within a construction material. The one or more linkages or bridges within the construction material may provide structural support for the construction material and/or provide a structural connection between at least two particles of a plurality of aggregate particles within the construction material. In some cases, the aggregate particles comprise sand, crushed stone, and/or gravel. The shape of the aggregate particles may be classified as either angular, subangular, subrounded, or rounded. Examples of a biocement include calcium carbonate bound to a preexisting particle of a solid material which was formed by microbiologically induced calcium carbonate precipitation (MICP). Further examples include biologically sintered metal carbonates, such as but not limited to calcium carbonate, magnesium carbonate, barium carbonate, or strontium carbonate.

As used herein, the term “bridging calcium carbonate” generally refers to calcium carbonate that is between, connects with, and/or binds together at least two moieties, such as aggregate particles. Together with the at least two moieties, the bridging calcium carbonate provides for a continuous piece comprising the at least two moieties and the bridging calcium carbonate. The calcium carbonate may be a solid, such as a precipitate. The calcium carbonate may be formed from the reaction of calcium ions with carbonate ions in aqueous solution, wherein the resulting calcium carbonate is integrated into a bulk composite material comprising calcium carbonate and the aggregate particles.

As used herein, the term “non-bridging calcium carbonate” generally refers to calcium carbonate that does not connect with or bind together at least two moieties, such as aggregate particles. The non-bridging calcium carbonate may be a precipitate that connects with only one moiety, such as an aggregate particle, or a precipitate that does not connect with any aggregate particle. The non-bridging calcium carbonate may be bound to at most one moiety.

As used herein, the terms “aggregate” or “aggregate particles” may be used interchangeably and generally refer to any type of particulate matter which can be bound together into larger particles or consolidated solids by biocement bonds or bridges. Nonlimiting examples of aggregates include sand, crushed stone, mine tailings, or combinations thereof, etc.

As used herein, the term “cementation reagents” generally refers to any combination of growth nutrients or starting materials, which when combined and allowed to react produce a binding agent via a biological mechanism. For example, an enzyme (or an organism containing an enzyme) can lead to the enzymatic formation of a biocement, such as calcium carbonate, which binds together adjacent aggregate particles. For example, cementation reagents in a urea-hydrolysis based biocementation system may comprise urea (or another suitable nitrogen source), a soluble calcium source (e.g., calcium chloride, calcium acetate, calcium phosphate, calcium lactate, calcium nitrate, etc.), nutrients which promote urease activity (which may vary depending on whether pure enzyme or urease-producing cells are used), and urease to form and precipitate a calcium carbonate biocement. In a calcium carbonate based biological sintering biocementation system, examples of biocementation reagents can comprise calcium carbonate, nutrients which promote enzymatic acid production, and an acid producing enzyme which generates acid to dissolve the calcium carbonate. Biocementation reagents for such a system may also comprise a second set of nutrients and a second enzyme which together promote a pH drop, reprecipitating calcium carbonate to form a biocement.

As used herein, the terms “produce,” “production,” and “producing” regarding calcium carbonate in the presence of an enzyme or a biological organism refer to the biological reactions enabled by the enzyme or the biological organism to produce the conditions to form calcium carbonate from starting materials such as calcium ion, carbonate ion, or other possible chemical entities. For example, an enzyme, which produces carbonate ion or calcium ion, can be called an enzyme producing calcium carbonate. An enzyme, which causes pH changes to enable the precipitation of calcium carbonate, can also be called an enzyme producing calcium carbonate.

As used herein, the term Microbiologically Induced Calcium Carbonate Precipitation (MICP) (also known as Microbially Induced Calcite Precipitation) generally refers to the production of calcium carbonate using at least one enzyme or biological organism. The at least one enzyme or biological organism can form either calcium ion or carbonate ion, or can change the pH of the environment to precipitate the calcium carbonate.

As used herein, “RPM” and “rpm” are used as units of an instantaneous rotational speed equivalent to revolutions per minute if that speed were maintained for a full minute (i.e., if the duty cycle is 100%).

### Construction Materials

The construction materials described herein can take many different forms and shapes. An example construction material, such as a unit or a brick with a top surface, four vertical sides and a bottom surface, may be used to illustrate the many features of the disclosed embodiments. However, the construction materials are not limited to the brick form only. For example, another example construction material can be a round tile with a top surface, a vertical circular side, and a bottom.

Structural biocement-based concrete (e.g., a biocement brick) may rely on the construction of interconnected calcium carbonate crystals to bind together surrounding aggregate particles. While biocement formation may be the product of Microbiologically Induced Calcite formation, MICP may result in calcium carbonate not related to the formation of structural biocement (e.g., an isolated calcium carbonate crystal that does not bind to more than one aggregate).

In some cases, connected biocement bridges may form as homogeneously as possible throughout the aggregate substrate/network, binding neighboring aggregate particles, thereby ensuring structural integrity throughout the product (e.g., one area may not be much stronger or much weaker than another). In some cases, the structural integrity of the product may be achieved by distributing MICP within the body of the biocement-based concrete such that the concentrations or weight percentages of the bridging calcium carbonate or calcium to silicon ratios at different cross-sections of the product differ no more than 70%, 65%, 60%, 55%, 50%, 45%, 40%, 35%, 30%, 25%, 20%, 15%, or 10% from each other.

When a MICP reaction forms non-connected, isolated, non-bridging calcium carbonate crystals, these crystals can fill pore-spaces between aggregate particles, preventing additional calcium carbonate formation required for structural bridging, thereby called clogging. Furthermore, when a solution containing calcium and urea is directionally applied to an aggregate substrate, if biocement is produced at a faster rate at the surface of solution application (the non-preferred surface), pore-space reduction by biocement formation or clogging can prevent biocement formation deeper within the unit/biocement-based concrete. In some cases, when homogenous biocementation (e.g., due to low variations of the degrees of MICP formation within the body of the unit) is difficult to achieve for a unit/biocement-based concrete, another goal can be to produce biocement at higher concentrations at the surface (the preferred surface) furthest away from the surface of solution application. The formation of non-structural, non-connected calcium carbonate crystals concentrated at the surface of the material can occur when pore-spaces are reduced to the point that the solution applied can no longer enter the inside of the unit. This phenomenon is described as a “crash-out”, which denotes formation of calcium carbonate on the surface of the unit. Preventing crash-out is desirable in practice to reduce the cost of direct materials, while improving product performance, consistency, and manufacturing repeatability. The early-stage formation of crash-out is an indicator that biocement or clogging has occurred first at the non-preferred surface (or the surface of solution application).

In some embodiments, preventing or reducing crash-out in practice is achieved (a) if the solution applied is free of particulate matter that can clog aggregate pore-spaces in a non-structural manner, and/or (b) the rate of cementation is not faster (or is slower) at the non-preferred surface (or the surface of solution application) or the rate of cementation is below a rate threshold.

Regarding (a): after searching for conditions that may reduce the formation of non-bridging calcium carbonate in a crash-out, the following conditions are identified: use filtration for the feed solution to prevent inert materials such as loose aggregate and/or plant matter from circulating within the supplied calcium solution and/or urea solutions. However, although feed solutions can be practically non-sterile, contamination from microorganisms in the aggregate matrix may contaminate the solution as free-floating cells. When MICP occurs outside the network of aggregates but in the solution surrounding the network of aggregates, discrete, isolated, non-connected calcium carbonate crystals are formed, which may also create particulate matter within the solution outside the aggregates. Therefore, it is also beneficial to inhibit/reduce biological activity (generating enzymes or biological organisms) within the solution, so that MICP primarily occurs only within the aggregate substrate in which biocement formation is desired. In practice, biological activity can be successfully inhibited with the application of UV radiation treatment and/or the induction of ozone and/or the blow of fresh air over the top of solution outside the aggregate network.

Regarding (b): one option is to use environmental and process controls to ensure the non-preferred surface may not build biocement faster than the preferred surface does. In some cases, the non-preferred surface is at the top surface as the feed solution may be applied from a fluid delivery system that relies on gravity to apply the feed solution. The rate of biocement formation may correlate with both the metabolic activity of the microorganisms or enzymes, and their rates of propagation (e.g., fermentation, doubling rate). Temperature, nutrient-availability, and respiration may influence biological activity of the microorganisms or enzymes. Therefore, options include (a) control the temperature of the process such that the temperature at or near the non-preferred surface is not higher than (or is less than) the temperature at or near the preferred surface, which may be controlled by ensuring that the aggregate substrate is warmer than the solution that is applied to the non-preferred surface; (b) nutrient in the feed solution is fully dissolved so that it can be homogeneously dispersed throughout the unit; and/or (c) in the case of anaerobic or facultatively-anaerobic microorganisms used for the MICP process, ensure that ample oxygen is available for respiration of the microorganisms, which may be achieved through regular air changes in a closed system, or natural ventilation in an open system.

Described herein are construction materials comprising a plurality of aggregate particles, bridging calcium carbonate crystals between at least two members of the plurality of aggregate particles, non-bridging calcium carbonate crystals, and at least one biological organism or enzyme producing at least some of the bridging calcium carbonate crystals. The construction materials may comprise at least one surface and a body enclosed by the at least one surface. The construction materials may comprise (i) a first average concentration of the non-bridging calcium carbonate crystals at or near the at least one surface is no more than a second average concentration of the bridging calcium carbonate crystals at or near the at least one surface, or (ii) the second average concentration differs no more than 70% from a third average concentration of the bridging calcium carbonate crystals at or near a cross-section of the body.

In some embodiments, the construction materials may comprise (i) a first average concentration of the non-bridging calcium carbonate crystals at or near the at least one surface is no more than a second average concentration of the bridging calcium carbonate crystals at or near the at least one surface, or (ii) the second average concentration differs no more than 70% from a third average concentration of the bridging calcium carbonate crystals at or near a cross-section of the body.

In some embodiments, a first average concentration of the non-bridging calcium carbonate crystals at or near the at least one surface is no more than a second average concentration of the bridging calcium carbonate crystals at or near the at least one surface. In some embodiments, the first average concentration is no more than the second average concentration. In some embodiments, the first average concentration is no more than 99%, 95%, 90%, 85%, 80%, 75%, 70%, 65%, or 60% of the second average concentration. In some embodiments, the first average concentration is from about 30% to about 100% of the second average concentration, from about 35% to about 95% of the second average concentration, from about 40% to about 90% of the second average concentration, from about 45% to about 85% of the second average concentration, from about 50% to about 80% of the second average concentration, or from about 55% to about 75% of the second average concentration. In some embodiments, the first average concentration is about the same as the second average concentration. In some embodiments, the first average concentration is no more than 170%, 165%, 160%, 155%, 150%, 145%, 140%, 135%, 130%, 125%, 120%, 115%, 110%, or 105% of the second average concentration.

In some embodiments, the second average concentration differs no more than 50% from the third average concentration. In some embodiments, the second average concentration differs no more than 69%, 65%, 60%, 55%, 50%, 45%, 40%, 35%, 30%, 25%, 20%, 15%, or 10% from the third average concentration. In some embodiments, the second average concentration differs from about 10% to about 70%, from about 15% to about 65%, from about 20% to about 60%, from about 25% to about 55%, from about 30% to about 50%, or from about 35% to about 45% from the third average concentration. In some embodiments, the second average concentration differs no more than 50% from the third average concentration. In some embodiments, the second average concentration differs no more than 69%, 65%, 60%, 55%, 50%, 45%, 40%, 35%, 30%, 25%, 20%, 15%, or 10% from the third average concentration.

In some embodiments, the construction material as described herein, wherein the at least one surface comprises a first surface and a second surface, and wherein the first average at or near the first surface differs no more than 50% from the first average at or near the second surface. In some embodiments, first average concentration at or near the first surface differs no more than 49%, 45%, 40%, 35%, 30%, 25%, 20%, 15%, or 10% from the first average concentration at or near the second surface.

Described herein are construction materials comprising (a) a first surface; (b) a second surface substantially opposite of the first surface; (c) one or more walls between and connecting the first surface and the second surface; and (d) a body enclosed by the first surface, the second surface and the one or more walls; (e) a plurality of aggregate particles; (f) bridging calcium carbonate crystals between at least two members of the plurality of aggregate particles; (g) non-bridging calcium carbonate crystals; and (h) at least one biological organism or enzyme producing at least some of the bridging calcium carbonate crystals, wherein a first average concentration of non-bridging calcium carbonate crystals on the first surface is at least about 10% higher than a second average concentration of non-bridging calcium carbonate crystals on the second surface.

In some embodiments, the first average concentration is at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 100% higher than the second average concentration. In some embodiment, the first average concentration is at least about 10% higher than a third average concentration of non-bridging calcium carbonate crystals at or near a cross-section of the body. In some embodiments, the first average concentration is at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 100% higher than the third average concentration. In some embodiments, (i) the first average concentration is more than a fourth average concentration of the bridging calcium carbonate crystals at or near the first surface, or (ii) the fourth average concentration differs no more than 70% from a fifth average concentration of the bridging calcium carbonate crystals at or near the cross-section of the body. In some embodiments, the fourth average concentration differs no more than 69%, 65%, 60%, 55%, 50%, 45%, 40%, 35%, 30%, 25%, 20%, 15%, or 10% of the fifth average concentration. In some embodiments, the at least one biological organism or enzyme comprises urease or cells of a urease-producing microorganism. In some embodiments, the at least one biological organism or enzyme comprises an acid-producing enzyme or cells of an acid-producing microorganism. In some embodiments, the at least one biological organism or enzyme comprises carbonic anhydrase or cells of a carbonic anhydrase-producing microorganism. In some embodiments, the at least one biological organism or enzyme comprises a urea-producing microorganism. In some embodiments, an average compression strength of the construction material is at least about 1,500 pound per square inch (psi). In some embodiments, the average compression strength is at least about 1,500, 1,600, 1,700, 1,800, 1,900, 2,000, 2,200, 2,400, 2,600, 2,800, 2,900, 3,000, 3,200, 3,400, 3,600, 3,800, 4,000, 4,200, 4,400, 4,600, 4,800, 5,000, 5,200, 5,400, 5,600, 5,800, 6,000, 6,200, 6,400, 6,600, or 6,800 psi.

### Weight Percentage of Calcium Carbonate

Described herein are construction materials comprising (a) a first surface; (b) a second surface substantially opposite of the first surface; (c) one or more walls between and connecting the first surface and the second surface; (d) a body enclosed by the first surface, the second surface and the one or more walls, the body comprises a plurality of aggregate particles; (e) calcium carbonate; and (f) at least one biological organism or enzyme producing at least some of calcium carbonate formed between at least two members of the plurality of aggregate particles, wherein a first average weight percentage of calcium carbonate on the first surface differs no more than 50% of a second average weight percentage of calcium carbonate on the second surface.

In some embodiments, the first average weight percentage differs no more than 50% of a third average weight percentage of calcium carbonate on a cross-section of the body. In some embodiments, the first average weight percentage differs no more than 49%, 45%, 40%, 35%, 30%, 25%, 20%, 15%, or 10% of the second average weight percentage. In some embodiments, the first average weight percentage differs no more than 49%, 45%, 40%, 35%, 30%, 25%, 20%, 15%, or 10% of the third average weight percentage.

### Porosity

Described herein are construction materials comprising (a) a first surface; (b) a second surface substantially opposite of the first surface; (c) one or more walls between and connecting the first surface and the second surface; (d) a body enclosed by the first surface, the second surface and the one or more walls, the body comprises a plurality of aggregate particles; (e) calcium carbonate; and (f) at least one biological organism or enzyme producing at least some of calcium carbonate formed between at least two members of the plurality of aggregate particles, wherein a first average porosity of the construction material is from 15% to 50%.

In some embodiments, the porosity can be measured by X-ray computed tomography data collected from 2-dimensional slices to produce a 3-dimensional image of the sample, thereby calculating the porosity of the sample. In some embodiments, porosity distribution can be determined by mercury intrusion porosimetry (MIP) analysis, which can provide information about the size and distribution of the pores present in the sample. In some embodiments, the porosity of a sample can be estimated by conducting a test on how much water can the sample absorb.

In some embodiments, a first average porosity on the first surface differs no more than 50% of a second average porosity on the second surface. In some embodiments, the first average porosity differs no more than 49%, 45%, 40%, 35%, 30%, 25%, 20%, 15%, or 10% of the second average porosity.

In some embodiments, a first average porosity on the first surface differs more than 50% of a second average porosity on the second surface. In some embodiments, the first average porosity differs more than 51%, 60%, 70%, 80%, 90%, 100%, 110%, 120%, 130%, 140%, 150%, 160%, 170%, 180%, 190%, 200%, or more from the second average porosity.

In some embodiments, a first average porosity on the first surface differs no more than 50% of a third average porosity on a cross-section of the body. In some embodiments, the first average porosity differs no more than 49%, 45%, 40%, 35%, 30%, 25%, 20%, 15%, or 10% of the third average porosity.

In some embodiments, a first average porosity on the first surface differs more than 50% of a third average porosity on a cross-section of the body. In some embodiments, the first average porosity differs no more than 51%, 60%, 70%, 80%, 90%, 100%, 110%, 120%, 130%, 140%, 150%, 160%, 170%, 180%, 190%, 200%, or more from the third average porosity.

In some embodiments, a first average porosity on the first surface is less than 50% of a second average porosity on the second surface. In some embodiments, the first average porosity is less than 49%, 45%, 40%, 35%, 30%, 25%, 20%, 15%, 10%, or 5% of the second average porosity.

In some embodiments, a first average porosity on the first surface is less than 50% of a third average porosity on a cross-section of the body. In some embodiments, the first average porosity is less than 49%, 45%, 40%, 35%, 30%, 25%, 20%, 15%, 10%, or 5% of the third average porosity.

In some embodiments, a first average porosity on the first surface is less than 50% of a third average porosity on a cross-section of the body, and the third average porosity is less than 50% of a second average porosity on the second surface. In some embodiments, the first average porosity is less than 49% of the third average porosity, and the third average porosity is less than 49%, 45%, 40%, 35%, 30%, 25%, 20%, 15%, 10%, or 5% of the second average porosity. In some embodiments, the first average porosity is less than 45% of the third average porosity, and the third average porosity is less than 49%, 45%, 40%, 35%, 30%, 25%, 20%, 15%, 10%, or 5% of the second average porosity. In some embodiments, the first average porosity is less than 40% of the third average porosity, and the third average porosity is less than 49%, 45%, 40%, 35%, 30%, 25%, 20%, 15%, 10%, or 5% of the second average porosity. In some embodiments, the first average porosity is less than 35% of the third average porosity, and the third average porosity is less than 49%, 45%, 40%, 35%, 30%, 25%, 20%, 15%, 10%, or 5% of the second average porosity. In some embodiments, the first average porosity is less than 30% of the third average porosity, and the third average porosity is less than 49%, 45%, 40%, 35%, 30%, 25%, 20%, 15%, 10%, or 5% of the second average porosity. In some embodiments, the first average porosity is less than 25% of the third average porosity, and the third average porosity is less than 49%, 45%, 40%, 35%, 30%, 25%, 20%, 15%, 10%, or 5% of the second average porosity. In some embodiments, the first average porosity is less than 20% of the third average porosity, and the third average porosity is less than 49%, 45%, 40%, 35%, 30%, 25%, 20%, 15%, 10%, or 5% of the second average porosity. In some embodiments, the first average porosity is less than 15% of the third average porosity, and the third average porosity is less than 49%, 45%, 40%, 35%, 30%, 25%, 20%, 15%, 10%, or 5% of the second average porosity. In some embodiments, the first average porosity is less than 10% of the third average porosity, and the third average porosity is less than 49%, 45%, 40%, 35%, 30%, 25%, 20%, 15%, 10%, or 5% of the second average porosity. In some embodiments, the first average porosity is less than 5% of the third average porosity, and the third average porosity is less than 49%, 45%, 40%, 35%, 30%, 25%, 20%, 15%, 10%, or 5% of the second average porosity.

### Density

Described herein are construction materials comprising (a) a first surface; (b) a second surface substantially opposite of the first surface; (c) one or more walls between and connecting the first surface and the second surface; (d) a body enclosed by the first surface, the second surface and the one or more walls, the body comprises a plurality of aggregate particles; (e) calcium carbonate; and (f) at least one biological organism or enzyme producing at least some of calcium carbonate formed between at least two members of the plurality of aggregate particles, wherein: 1) an average green density of the construction material is from about 1.5 g/cc to about 2.5 g/cc, or 2) an average finished density of the construction material is from about 1.8 g/cc to about 2.7 g/cc, or 3) an average percentage of void of green density is from about 25% to about 46%, or 4) an average percentage of void filled in the finished product (e.g., an average of percentage of CaCO3 made) is from about 5% to about 25%, or 5) any combination thereof. As used herein, the unit “g/cc” generally refers to the unit grams per cubic centimeter (g/cm3), which is a unit for density. The percentage of void within a portion of a construction material may correspond to an average porosity for the portion of the construction material.

As used herein, the term “green density” generally refers to the density of the construction material before sintering. The term “green density” may refer to wet green density, which may comprise the density of a pressed unit at the time of pressing, or to dry green density, which may comprise the density of a pressed unit that has been completely dried out.

As used herein, the term “finished density” generally refers to the density of the construction material after sintering. In some embodiments, the average green density is from about 1.5 g/cc to about 1.8 g/cc, from about 1.6 g/cc to about 1.9 g/cc, from about 1.7 g/cc to about 2.0 g/cc, from about 1.8 g/cc to about 2.1 g/cc, from about 1.9 g/cc to about 2.2 g/cc, from about 2.0 g/cc to about 2.3 g/cc, from about 2.1 g/cc to about 2.4 g/cc. In some embodiments, the average green density is from about 1.7 g/cc to about 2.0 g/cc. In some embodiments, the average green density is about 1.5, 1.6, 1.7, 1.8, 1.9, 2.0, 2.1, 2.2, 2.3, or 2.4 g/cc. In some embodiments, the average finished density is from about 1.8 g/cc to about 1.9 g/cc, from about 1.9 g/cc to about 2.0 g/cc, from about 2.0 g/cc to about 2.1 g/cc, from about 2.1 g/cc to about 2.2 g/cc, from about 2.2 g/cc to about 2.3 g/cc, from about 2.3 g/cc to about 2.4 g/cc, from about 2.4 g/cc to about 2.5 g/cc, from about 2.5 g/cc to about 2.6 g/cc, or from about 2.6 g/cc to about 2.7 g/cc. In some embodiments, the average finished density is from about 2.0 g/cc to about 2.1 g/cc. In some embodiments, the average finished density is about 1.8, 1.9, 2.0, 2.1, 2.2, 2.3, 2.4, 2.5, 2.6 or 2.7 g/cc. In some embodiments, the average percentage of void of green density is from about 25% to about 28%, from about 28% to about 31%, from about 31% to about 34%, from about 34% to about 37%, from about 37% to about 40%, from about 40% to about 43%, or from about 43% to about 46%. In some embodiments, the average percentage of void of green density is from about 30% to about 42%. In some embodiments, the average percentage of void of green density is about 25%, 26%, 27%, 28%, 29%, 30%, 31%, 32%, 33%, 34%, 35%, 36%, 37%, 38%, 39%, 40%, 31%, 42%, 43%, 44%, 45%, 46%, or 47%. In some embodiments, the average of percentage of CaCO 3 made is from about 5% to about 10%, from about 10% to about 15%, from about 15% to about 20%, or from about 20% to about 25%. In some embodiments, the average of percentage of CaCO 3 made is from 10% to about 23%. In some embodiments, the average of percentage of CaCO 3 made is about 5%, 6%, 7%, 8%, 9%, 10%, 11%, 12%, 13%, 14%, 15%, 16%, 17%, 18%, 19%, 20%, 21%, 22%, 23%, 24%, or 25%.

### Homogeneity

Described herein are construction materials comprising (a) a first surface; (b) a second surface substantially opposite of the first surface; (c) one or more walls between and connecting the first surface and the second surface; (d) a body enclosed by the first surface, the second surface and the one or more walls, the body comprises a plurality of aggregate particles; (e) calcium carbonate; and (f) at least one biological organism or enzyme producing at least some of calcium carbonate formed between at least two members of the plurality of aggregate particles, wherein the homogeneity of the bio-cement formed is evaluated by the compressive strength profiles from the top surface to the bottom surface, or from the percentage of calcium carbonate distribution profiles from the top surface to the bottom surface, or from comparing images made from SEM/EDX (scanning electron microscopy with energy dispersive X-ray spectroscopy) with the compressive strength of selected layers away from the top or bottom surfaces.

In some embodiments, by comparing samples from the pass or fail units based on compressive strength, the pass units comprise higher percentage of calcium carbonate, thereby higher percentage of bio-cement (or biologically formed calcium carbonate). In some embodiments, the distribution of bio-cement is more homogenous or unified (e.g., smaller variation among layers of different depths from the top surface) in the pass units than in the failed units. In some embodiments, the distribution of bio-cement is evaluated by the percentage of calcium carbonate, or percentage of calcium carbonate made, or percentage of void after sintering. In some embodiments, the temperature for the sintering is lower for making the construction material of this disclosure comprising bio-cement than for making the traditional construction material comprising substantially no bio-cement (e.g., construction material comprising no more than 5%, 4%, 3%, 2%, or 1% bio-cement in calcium carbonate).

### Materials/Compositions

The construction materials according to the disclosure may be substantially homogeneous. In some embodiments, the construction materials according to the disclosure and methods herein result may be substantially continuous. In some embodiments, the construction materials are substantially homogeneous. In some embodiments, the construction materials are substantially porous.

The plurality of aggregate particles may comprise any type of natural rock or stone, glass, fiberglass, wood, biomass, paper, metal, plastic, polymers, rubber, imitation rubber, vinyl, minerals, imitations of rock or stone, recycled materials such as, for example, recycled brick, concrete, stone, mine tailings and mining residues, scrubber wastes, and/or combinations thereof. The plurality of aggregate particles can be of any size including mixtures of sizes provided such aggregate is smaller in size than the resulting structure. The plurality of aggregate particles may comprise particles of 10 mm or less, 5 mm or less, 1 mm or less, 0.5 mm or less, or combinations thereof. Mesh sizes can be as desired including but not limited to very fine particles (any number between and including 32-300 standard mesh), fine particles (any number between and including 10-32 standard mesh), medium particles (less than 10 standard mesh including all mesh numbers therein), and coarse particles (particles greater than or equal to 2 mm), and combinations thereof. Particle can be most any shape including, for example, round or rounded, oval, spherical (S grade), square, rectangular, tetrahedral, pentahedral, polyhedral, fiber, lath, angular, elongated, needle-like, acicular, flat, flaky, cylindrical, spongy, cubic, cubical and combinations and variations thereof. If desired or necessary, aggregate particles can be roughened to create cracks in and crevices on particle surfaces.

The aggregate material may comprise rock (e.g., fines), sand, glass, wood, paper, metal, plastic, polymers, minerals, manufacturing or processing waste materials such as ash, carbon, or wood residuals, any of which can be crushed or used whole or combinations thereof.

The aggregate material may comprise organic or inorganic material such as, for example, sand, rock, glass (e.g., Poraver), wood, paper, metal, plastic, polymers, minerals, recycled materials, or combinations thereof. Aggregate particles may comprise beads, grains, rods, strands, fibers, flakes, crystals, pulverized or crushed materials, or combinations thereof.

Aggregate particles may have a diameter (e.g., actual, average, or effective diameter) of about 50 mm or less, preferably about 25 mm or less, preferably about 20 mm or less, preferably about 10 mm or less, and preferably about 5 mm or less. In some embodiments, aggregate material may be about 1 mm or less and about 0.5 mm or less, about 0.1 mm or less, and about 50 μm or less. Particles sizes may include from about 10 μm to about 1 mm, from about 100 μm to about 0.5 mm, from about 200 μm to about 1 mm, from about 1 μm to about 200 μm, from about 10 nm to about 1 μm, and from about 10 nm to about 40 nm, and various combinations thereof. Aggregate particles may be largely composed of particulates of less than 5 mm in diameter (e.g., less than or about 4 mm, less than or about 3 mm, less than or about 2 mm, or less than or about 1 mm).

Aggregate particles may be characterized by fine size and may be equal to or less than 250 micron, equal to or less than 200 micron, equal to or less than 150 micron, or equal to or less than 100 micron (reference examples include micron size of beach sand=700, micron size of fine sand=250; micron size of Portland cement=74; micron size of silt=44; micron size of smoke=2).

In some embodiments large particles may be used, e.g., aggregates comprising particles of cm or mm size, e.g., gravels, stones, crushed rocks etc. In some embodiments, the size range of particles may range from 1 μm, or 10 μm, to 5 cm, or more. In some embodiments, the particulate starting material may consist of, or at least essentially consist of, small particles, in particular particles on a μm scale. In other words, the particles may be between, or in the range of 1 μm and 1 mm (1000 μm) in size, for instance between, or in the range of, 100 and 1000 μm or 100 and 500 μm, for example 200 and 400 μm, or 200 and 300 μm. Large size particles may however be, for instance, between 1 mm and 2 mm in size, or have a wider range in size, for instance between 100 μm and 2 mm.

The bridging calcium carbonate may bond to individual aggregate particles to create bridges between the aggregate particles, or it may encapsulate individual aggregate particles. The bridging calcium carbonate may be formed from the reaction of calcium and carbonate ions. The enzyme or enzyme-producing biological organism and the reagents may be added together or separately to result in the formation of calcium carbonate. The calcium carbonate may be a precipitated calcium carbonate. In some embodiments, the bridging calcium carbonate may be crystals, such as bridging calcium carbonate crystals. In some embodiments, the bridging calcium carbonate crystals are ordered, pseudocrystalline, or amorphous. In some embodiments, the bridging calcium carbonate crystals are macroscopically ordered and comprise a trigonal, orthorhombic, or hexagonal crystal structure.

The at least one biological organism or enzyme may comprise a urease-producing microorganism. The urease-producing microorganism may be selected from the group of: Sporosarcina pasteurii, Sporosarcina ureae, Proteus vulgaris, Bacillus sphaericus, Myxococcus xanthus, Proteus mirabilis, Bacillus megaterium, Helicobacter pylori, and combinations of two or more thereof.

The at least one biological organism or enzyme may comprise an enzyme producing biological organism. The enzyme producing biological organism may be an acid producing microorganism. The acid-producing microorganism may be selected from the group consisting of: Variovorax, Klebsiella, Pseudomonas, Bacillus, Exiguobacterium, Microbacterium, Curtobacterium, Rathayibacter, CellFimi 2, Streptomyces, Raoultella, B. pumilus, B. safanensis, B. simplex, B. licheniformis, and combinations thereof.

In some embodiments, the construction material may further comprise a binding agent. The binding agent that can be generated through a biological mechanism (such as an enzymatic process) which adheres to or encapsulates aggregate particles. In some embodiments, the binding agent may be a biological organism or enzyme. The biological organism may be any urease-producing organism, acid-producing organism, or a carbonic anhydrase-producing organism. The enzyme may be urease or carbonic anhydrase.

### Physical Properties of Construction Material

In some embodiments, a construction material has a compressive strength of about 900 psi to about 3,500 psi. In some embodiments, a construction material has a compressive strength of about 900 psi to about 1,000 psi, about 900 psi to about 1,100 psi, about 900 psi to about 1,200 psi, about 900 psi to about 1,300 psi, about 900 psi to about 1,400 psi, about 900 psi to about 1,600 psi, about 900 psi to about 1,800 psi, about 900 psi to about 2,000 psi, about 900 psi to about 2,500 psi, about 900 psi to about 3,000 psi, about 900 psi to about 3,500 psi, about 1,000 psi to about 1,100 psi, about 1,000 psi to about 1,200 psi, about 1,000 psi to about 1,300 psi, about 1,000 psi to about 1,400 psi, about 1,000 psi to about 1,600 psi, about 1,000 psi to about 1,800 psi, about 1,000 psi to about 2,000 psi, about 1,000 psi to about 2,500 psi, about 1,000 psi to about 3,000 psi, about 1,000 psi to about 3,500 psi, about 1,100 psi to about 1,200 psi, about 1,100 psi to about 1,300 psi, about 1,100 psi to about 1,400 psi, about 1,100 psi to about 1,600 psi, about 1,100 psi to about 1,800 psi, about 1,100 psi to about 2,000 psi, about 1,100 psi to about 2,500 psi, about 1,100 psi to about 3,000 psi, about 1,100 psi to about 3,500 psi, about 1,200 psi to about 1,300 psi, about 1,200 psi to about 1,400 psi, about 1,200 psi to about 1,600 psi, about 1,200 psi to about 1,800 psi, about 1,200 psi to about 2,000 psi, about 1,200 psi to about 2,500 psi, about 1,200 psi to about 3,000 psi, about 1,200 psi to about 3,500 psi, about 1,300 psi to about 1,400 psi, about 1,300 psi to about 1,600 psi, about 1,300 psi to about 1,800 psi, about 1,300 psi to about 2,000 psi, about 1,300 psi to about 2,500 psi, about 1,300 psi to about 3,000 psi, about 1,300 psi to about 3,500 psi, about 1,400 psi to about 1,600 psi, about 1,400 psi to about 1,800 psi, about 1,400 psi to about 2,000 psi, about 1,400 psi to about 2,500 psi, about 1,400 psi to about 3,000 psi, about 1,400 psi to about 3,500 psi, about 1,600 psi to about 1,800 psi, about 1,600 psi to about 2,000 psi, about 1,600 psi to about 2,500 psi, about 1,600 psi to about 3,000 psi, about 1,600 psi to about 3,500 psi, about 1,800 psi to about 2,000 psi, about 1,800 psi to about 2,500 psi, about 1,800 psi to about 3,000 psi, about 1,800 psi to about 3,500 psi, about 2,000 psi to about 2,500 psi, about 2,000 psi to about 3,000 psi, about 2,000 psi to about 3,500 psi, about 2,500 psi to about 3,000 psi, about 2,500 psi to about 3,500 psi, or about 3,000 psi to about 3,500 psi. In some embodiments, a construction material has a compressive strength of about 900 psi, about 1,000 psi, about 1,100 psi, about 1,200 psi, about 1,300 psi, about 1,400 psi, about 1,600 psi, about 1,800 psi, about 2,000 psi, about 2,500 psi, about 3,000 psi, or about 3,500 psi. In some embodiments, a construction material has a compressive strength of at least about 900 psi, about 1,000 psi, about 1,100 psi, about 1,200 psi, about 1,300 psi, about 1,400 psi, about 1,600 psi, about 1,800 psi, about 2,000 psi, about 2,500 psi, or about 3,000 psi. In some embodiments, a construction material has a compressive strength of at most about 1,000 psi, about 1,100 psi, about 1,200 psi, about 1,300 psi, about 1,400 psi, about 1,600 psi, about 1,800 psi, about 2,000 psi, about 2,500 psi, about 3,000 psi, or about 3,500 psi.

In some embodiments, the mass of calcium carbonate, bridging and nonbridging, in a construction material is about 0.01 weight % to about 20 weight %. In some embodiments, the mass of calcium carbonate in a construction material is about 0.01 weight % to about 0.1 weight %, about 0.01 weight % to about 0.5 weight %, about 0.01 weight % to about 1 weight %, about 0.01 weight % to about 2 weight %, about 0.01 weight % to about 3 weight %, about 0.01 weight % to about 4 weight %, about 0.01 weight % to about 5 weight %, about 0.01 weight % to about 7 weight %, about 0.01 weight % to about 10 weight %, about 0.01 weight % to about 15 weight %, about 0.01 weight % to about 20 weight %, about 0.1 weight % to about 0.5 weight %, about 0.1 weight % to about 1 weight %, about 0.1 weight % to about 2 weight %, about 0.1 weight % to about 3 weight %, about 0.1 weight % to about 4 weight %, about 0.1 weight % to about 5 weight %, about 0.1 weight % to about 7 weight %, about 0.1 weight % to about 10 weight %, about 0.1 weight % to about 15 weight %, about 0.1 weight % to about 20 weight %, about 0.5 weight % to about 1 weight %, about 0.5 weight % to about 2 weight %, about 0.5 weight % to about 3 weight %, about 0.5 weight % to about 4 weight %, about 0.5 weight % to about 5 weight %, about 0.5 weight % to about 7 weight %, about 0.5 weight % to about 10 weight %, about 0.5 weight % to about 15 weight %, about 0.5 weight % to about 20 weight %, about 1 weight % to about 2 weight %, about 1 weight % to about 3 weight %, about 1 weight % to about 4 weight %, about 1 weight % to about 5 weight %, about 1 weight % to about 7 weight %, about 1 weight % to about 10 weight %, about 1 weight % to about 15 weight %, about 1 weight % to about 20 weight %, about 2 weight % to about 3 weight %, about 2 weight % to about 4 weight %, about 2 weight % to about 5 weight %, about 2 weight % to about 7 weight %, about 2 weight % to about 10 weight %, about 2 weight % to about 15 weight %, about 2 weight % to about 20 weight %, about 3 weight % to about 4 weight %, about 3 weight % to about 5 weight %, about 3 weight % to about 7 weight %, about 3 weight % to about 10 weight %, about 3 weight % to about 15 weight %, about 3 weight % to about 20 weight %, about 4 weight % to about 5 weight %, about 4 weight % to about 7 weight %, about 4 weight % to about 10 weight %, about 4 weight % to about 15 weight %, about 4 weight % to about 20 weight %, about 5 weight % to about 7 weight %, about 5 weight % to about 10 weight %, about 5 weight % to about 15 weight %, about 5 weight % to about 20 weight %, about 7 weight % to about 10 weight %, about 7 weight % to about 15 weight %, about 7 weight % to about 20 weight %, about 10 weight % to about 15 weight %, about 10 weight % to about 20 weight %, or about 15 weight % to about 20 weight %. In some embodiments, the mass of calcium carbonate in a construction material is about 0.01 weight %, about 0.1 weight %, about 0.5 weight %, about 1 weight %, about 2 weight %, about 3 weight %, about 4 weight %, about 5 weight %, about 7 weight %, about 10 weight %, about 15 weight %, or about 20 weight %. In some embodiments, the mass of calcium carbonate in a construction material is at least about 0.01 weight %, about 0.1 weight %, about 0.5 weight %, about 1 weight %, about 2 weight %, about 3 weight %, about 4 weight %, about 5 weight %, about 7 weight %, about 10 weight %, or about 15 weight %. In some embodiments, the mass of calcium carbonate in a construction material is at most about 0.1 weight %, about 0.5 weight %, about 1 weight %, about 2 weight %, about 3 weight %, about 4 weight %, about 5 weight %, about 7 weight %, about 10 weight %, about 15 weight %, or about 20 weight %.

### Systems for Producing a Construction Material

Described herein are systems for a plurality of frameworks, each of the plurality of frameworks comprises a bottom, one or more walls. In some embodiments, the bottom and the one or more walls together define a space. In some embodiments, the systems may further comprise an inlet or feed source configured to add cementation reagents to the space. In some embodiments, the systems may further comprise an outlet configured to remove a mobile phase from the space, wherein the mobile phase comprises depleted cementation reagents; (b) a heat exchange system in thermal communication with the plurality of frameworks; and (c) a controller in communication with the inlet, the outlet, and the heat exchange system, wherein the controller is configured to control a duty cycle of the system. The duty cycle comprises adding the cementation reagents to the space, removing the mobile phase from the space, and keeping a temperature of the bottom higher than a temperature of the cementation reagents in the inlet while adding the cementation reagents.

The heat exchange system may be programmed to introduce a temperature gradient along the plurality of frameworks. In some embodiments, the heat exchange system may be programmed to introduce and/or maintain a constant temperature along the plurality of the frameworks. In some embodiments, the heat exchange system may be programmed to introduce discrete temperatures along different regions along the plurality of the frameworks. The heat exchange systems used herein may include a heat exchanger. The controller configured to control a duty cycle of the system may be a controller or electronic system.

In some embodiments, the duty cycle enables control over directed crystal growth of calcium carbonate to form bridging calcium carbonate. In some embodiments, the duty cycle further comprises cooling/heating the bottom and/or the one or more walls after completing adding the cementation reagents. In some embodiments, the duty cycle further comprises cooling/heating the inlet during and/or after adding the cementation reagents. In some embodiments, the duty cycle further comprises adding air, oxygen or ozone to the space or a top of the space; and/or removing air, oxygen or ozone from the space or the top of the space. In some embodiments, the duty cycle further comprises radiating the space using ultraviolet light. In some embodiments, the duty cycle further comprises vibrating the plurality of frameworks.

In some embodiments, a hydroponic method is used to make construction materials comprising bio-cement. In some embodiments, the plurality of frameworks is also called a plurality of reaction chambers. In some embodiments, each framework or reaction chamber is loaded with aggregated particles, pretreated or not-pretreated. In some embodiments, in the first bath, a first feed-on solution/liquid is added to each framework/reaction chamber during the “feed-on” state/cycle of the duty cycle. In some embodiments, the temperature of the feed-on solution/liquid is controlled. In some embodiments, no feed-on solution/liquid is provided to each framework/reaction chamber during the “feed-off” state/cycle of the duty cycle. In some embodiments, the bottom of the framework/reaction chamber is heated by a heat exchange device or a heater. In some embodiments, the feed-on solution/fluid is added from the top (or top opening of or an inlet near the top of the framework/reaction chamber). In some embodiments, either near the end of or after the end of the feed-off state/cycle, the remaining feed-on solution/fluid is substantially drained before the start of the next cycle (e.g., a subsequent feed-on cycle/state).

### Methods of Producing Construction Materials

Methods of manufacturing described herein can be used to make any of the construction materials described herein. Methods may comprise adding a plurality of aggregate particles and at least one biological organism or enzyme to a framework, thus forming a framed plurality of aggregate particles. The aggregate particles may comprise at least one surface and a body enclosed by the at least one surface, wherein the at least one biological organism or enzyme resides at least in the body. Cementation reagents may be fed into the framed plurality of aggregate particles. The method comprises controlling a first temperature of the body relative to (i) a second temperature of the fed cementation reagents, and/or a third temperature above the framed plurality of aggregate particles. The method comprises forming bridging calcium carbonate crystals between at least two members of the framed plurality of aggregate particles and non-bridging calcium carbonate crystals from starting materials produced by the at least one biological organism or enzyme.

In some embodiments, the process of producing the construction materials may be a hydroponic process. In some embodiments, during the hydroponics process, each of a plurality of pressed aggregate units is fed with calcium ion source chemical and carbonate ion source chemical to form bio-cement (or calcium carbonate formed from biologically generated calcium ion and/or carbonate ion), which is a biologically formed calcium carbonate. In some embodiments, this bio-cement (calcium carbonate) formation process may happen in the voids of the pressed aggregate units. In some embodiments, the calcium ion is formed biologically. In some embodiments, the carbonate ion is formed biologically. In some embodiments, both the calcium ion and the carbonate ion are formed biologically. As used herein, the term “formed biologically” generally refers to the formation of a product from a starting material by a biological agent. In some embodiments, the biological agent may be one or more enzymes, one or more microorganisms, or a combination thereof. In some embodiments, this bio-cement (calcium carbonate) formation process may bridge the gaps between aggregate particles within each of the plurality of pressed aggregate unit. In some embodiments, the hydroponic process comprises some, or all of, steps of aggregate blend preparation, germination, press, drying, feeding, deodorization, and finish. In some embodiments, each of the steps of aggregate blend preparation, germination, press, drying, feeding, deodorization, and finish is performed with controlled parameters. In some embodiments, the product formed may be evaluated based on parameters including, but not limited to, compression strength, flexural strength, absorption, and sustaining freeze thaw cycles.

In some embodiments, the duty cycle comprises a feed process that provides reagents to the framework. In some embodiments, the feed process comprises a duty cycle comprising a plurality of cycles with parameters comprising independent feed-on time and fed-off time for each cycle, and a total number of cycles. In some embodiments, the duty cycle of the feed process comprises a first bath and a plurality of subsequent bath. In some embodiments, the first bath comprises a first feed-on time that is from about 80 seconds to about 120 seconds. In some embodiments, the first feed-on time is from about 80 seconds to about 85 seconds, from about 85 seconds to about 90 seconds, from about 90 seconds to about 95 seconds, from about 95 seconds to about 100 seconds, from about 100 seconds to about 105 seconds, from about 105 seconds to about 110 seconds, from about 110 seconds to about 115 seconds, or from about 115 seconds to about 120 seconds. In some embodiments, the first feed-on time is about 80, 85, 90, 95, 100, 105, 110, 115, or 120 seconds. In some embodiments, the first feed-on time is about 100 seconds. In some embodiments, the first bath comprises a first feed-off time that is from about 800 seconds to about 1,000 seconds. In some embodiments, the first feed-off time is from about 800 seconds to about 820 seconds, from about 820 seconds to about 840 seconds, from about 840 seconds to about 860 seconds, from about 860 seconds to about 880 seconds, from about 880 seconds to about 900 seconds, from about 900 seconds to about 920 seconds, from about 920 seconds to about 940 seconds, from about 940 seconds to about 960 seconds, from about 960 seconds to about 980 seconds, or from about 980 seconds to about 1,000 seconds. In some embodiments, the first feed-on time is about 800, 810, 820, 830, 840, 850, 860, 870, 880, 890, 900, 910, 920, 930, 940, 950, 960, 970, 980, 990, or 1,000 seconds. In some embodiments, the first feed-off time is about 900 seconds.

In some embodiments, each of the plurality of subsequent bath independently comprises a subsequent feed-on time that is from about 80 seconds to about 120 seconds. In some embodiments, the subsequent feed-on time is independently from about 80 seconds to about 85 seconds, from about 85 seconds to about 90 seconds, from about 90 seconds to about 95 seconds, from about 95 seconds to about 100 seconds, from about 100 seconds to about 105 seconds, from about 105 seconds to about 110 seconds, from about 110 seconds to about 115 seconds, or from about 115 seconds to about 120 seconds. In some embodiments, the subsequent feed-on time is independently about 80, 85, 90, 95, 100, 105, 110, 115, or 120 seconds. In some embodiments, the subsequent feed-on time is independently about 100 seconds. In some embodiments, each of the plurality of subsequent bath independently comprises a subsequent feed-off time that is from about 400 seconds to about 600 seconds. In some embodiments, the subsequent feed-off time is independently from about 400 seconds to about 420 seconds, from about 420 seconds to about 440 seconds, from about 440 seconds to about 460 seconds, from about 460 seconds to about 480 seconds, from about 480 seconds to about 500 seconds, from about 500 seconds to about 520 seconds, from about 520 seconds to about 540 seconds, from about 540 seconds to about 560 seconds, from about 560 seconds to about 580 seconds, or from about 580 seconds to about 600 seconds. In some embodiments, the subsequent feed-on time is independently about 400, 410, 420, 430, 440, 450, 460, 470, 480, 490, 500, 510, 520, 530, 540, 550, 560, 570, 580, 590, or 600 seconds. In some embodiments, the subsequent feed-off time is independently about 500 seconds. In some embodiments, the total number of cycles is from about 15 to about 40 cycles. In some embodiments, the total number of cycles is from about 15 to about 22, from about 17 to about 24, from about 19 to about 26, from about 21 to about 28, from about 23 to about 30, from about 25 to about 32, from about 27 to about 34, from about 29 to about 36, from about 31 to about 38, or from about 33 to about 40 cycles. In some embodiments, the total number of cycles is from about 23 to about 30 cycles. In some embodiments, the total number of cycles is about 15, 16, 17, 18, 19, 20, 21, 22, 23, 24, 25, 26, 27, 28, 29, 30, 31, 32, 33, 34, 35, 36, 37, 38, 39, or 40 cycles.

In some embodiments, the feed-on solution/fluid comprises urea and calcium salt (e.g., calcium chloride or other calcium²⁺-containing salts). In some embodiments, the concentration of urea is from about 180 mM to about 330 mM. In some embodiments, the concentration of urea is from about 180 mM to about 190 mM, from about 190 mM to about 200 mM, from about 200 mM to about 210 mM, from about 210 mM to about 220 mM, from about 220 mM to about 230 mM, from about 230 mM to about 240 mM, from about 240 mM to about 250 mM, from about 250 mM to about 260 mM, from about 260 mM to about 270 mM, from about 270 mM to about 280 mM, from about 280 mM to about 290 mM, from about 290 mM to about 300 mM, from about 300 mM to about 310 mM, from about 310 mM to about 320 mM, or from about 320 mM to about 330 mM. In some embodiments, the concentration of urea is about 180, 190, 200, 210, 220, 230, 240, 250, 260, 270, 280, 290, 300, 310, 320, or 330 mM. In some embodiments, the concentration of urea is about 230 mM. In some embodiments, the concentration of urea is about 240 mM. In some embodiments, the concentration of urea is about 240 mM. In some embodiments, the concentration of urea is about 260 mM. In some embodiments, the concentration of urea is about 270 mM. In some embodiments, the concentration of urea is about 280 mM. In some embodiments, the concentration of calcium chloride is from about 180 mM to about 330 mM. In some embodiments, the concentration of calcium chloride is from about 180 mM to about 190 mM, from about 190 mM to about 200 mM, from about 200 mM to about 210 mM, from about 210 mM to about 220 mM, from about 220 mM to about 230 mM, from about 230 mM to about 240 mM, from about 240 mM to about 250 mM, from about 250 mM to about 260 mM, from about 260 mM to about 270 mM, from about 270 mM to about 280 mM, from about 280 mM to about 290 mM, from about 290 mM to about 300 mM, from about 300 mM to about 310 mM, from about 310 mM to about 320 mM, or from about 320 mM to about 330 mM. In some embodiments, the concentration of calcium chloride is about 180, 190, 200, 210, 220, 230, 240, 250, 260, 270, 280, 290, 300, 310, 320, or 330 mM. In some embodiments, the concentration of calcium chloride is about 230 mM. In some embodiments, the concentration of calcium chloride is about 240 mM. In some embodiments, the concentration of calcium chloride is about 240 mM. In some embodiments, the concentration of calcium chloride is about 260 mM. In some embodiments, the concentration of calcium chloride is about 270 mM. In some embodiments, the concentration of calcium chloride is about 280 mM. In some embodiments, the concentration of the urea is about the same as the concentration of the calcium chloride. In some embodiments, the concentration of the urea is different from the concentration of the calcium chloride.

In some embodiments, the act of controlling a first temperature of the body comprises heating/cooling a bottom of the framework. In some embodiments, the act of controlling a first temperature of the body comprises heating the bottom of the framework. In some embodiments, the act of controlling a first temperature of the body comprises heating/cooling the fed cementation reagents. In some embodiments, the act of controlling a first temperature of the body comprises cooling the fed cementation reagents. In some embodiments, the act of controlling a first temperature comprises heating/cooling the solution phase above the framed plurality of aggregate particles.

In some embodiments, the duty cycle may comprise controlled temperature ranges for a plurality of components. In some embodiments, the plurality of components whose temperatures are controlled comprises a first temperature of each framework/body/reaction chamber in which the pressed aggregates are bond by bio-cement, a second temperature of the feed-on solution/liquid, and/or a differential between the first and second temperatures. In some embodiments, the first temperature (i.e., the temperature of each framework/body/reaction chamber) is from about 28° C. to about 38° C. In some embodiments, the first temperature is from about 28° C. to about 30° C., from about 30° C. to about 32° C., from about 32° C. to about 34° C., from about 34° C. to about 36° C., or from about 36° C. to about 38° C. In some embodiments, the first temperature is from about 32° C. to about 34° C. In some embodiments, the first temperature is about 28° C., 29° C., 30° C., 31° C., 32° C., 33° C., 34° C., 35° C., 36° C., 37° C., or 38° C. In some embodiments, the second temperature (i.e., the temperature of the feed-on solution/fluid) is from about 26° C. to about 37° C. In some embodiments, the second temperature is from about 26° C. to about 27° C., from about 27° C. to about 28° C., from about 28° C. to about 29° C., from about 29° C. to about 30° C., from about 30° C. to about 31° C., from about 31° C. to about 32° C., from about 32° C. to about 33° C., from about 33° C. to about 34° C., from about 34° C. to about 35° C., from about 35° C. to about 36° C., or from about 36° C. to about 37° C. In some embodiments, the second temperature is from about 30° C. to about 31° C. In some embodiments, the second temperature is about 26° C., 27° C., 28° C., 29° C., 30° C., 31° C., 32° C., 33° C., 34° C., 35° C., 36° C., or 37° C. In some embodiments, the differential between the first and second temperatures is about 1° C., about 2° C., or about 3° C. In some embodiments, the differential between the first and second temperatures is about 1° C. In some embodiments, the differential between the first and second temperatures is about 2° C. In some embodiments, the differential between the first and second temperatures is about 3° C. In some embodiments, the first temperature is about 36° C. and the second temperature is about 35° C. In some embodiments, the first temperature is about 36° C. and the second temperature is about 34° C. In some embodiments, the first temperature is about 36° C. and the second temperature is about 33° C. In some embodiments, the first temperature is about 35° C. and the second temperature is about 34° C. In some embodiments, the first temperature is about 35° C. and the second temperature is about 33° C. In some embodiments, the first temperature is about 35° C. and the second temperature is about 32° C. In some embodiments, the first temperature is about 34° C. and the second temperature is about 33° C. In some embodiments, the first temperature is about 34° C. and the second temperature is about 32° C. In some embodiments, the first temperature is about 34° C. and the second temperature is about 31° C. In some embodiments, the first temperature is about 33° C. and the second temperature is about 32° C. In some embodiments, the first temperature is about 33° C. and the second temperature is about 31° C. In some embodiments, the first temperature is about 33° C. and the second temperature is about 30° C. In some embodiments, the first temperature is about 32° C. and the second temperature is about 31° C. In some embodiments, the first temperature is about 32° C. and the second temperature is about 30° C. In some embodiments, the first temperature is about 32° C. and the second temperature is about 29° C. In some embodiments, the first temperature is about 31° C. and the second temperature is about 30° C. In some embodiments, the first temperature is about 31° C. and the second temperature is about 29° C. In some embodiments, the first temperature is about 31° C. and the second temperature is about 28° C. In some embodiments, the first temperature is about 30° C. and the second temperature is about 29° C. In some embodiments, the first temperature is about 30° C. and the second temperature is about 28° C. In some embodiments, the first temperature is about 30° C. and the second temperature is about 27° C. In some embodiments, the first temperature is about 29° C. and the second temperature is about 28° C. In some embodiments, the first temperature is about 29° C. and the second temperature is about 27° C. In some embodiments, the first temperature is about 29° C. and the second temperature is about 26° C.

In some embodiments, the method may further comprise adding air, oxygen, or ozone over a top of the framework. In some embodiments, the method may further comprise removing air, oxygen, or ozone from the top of the framework.

In some embodiments, the method may further comprise curing the framed plurality of aggregate particles. In some embodiments, the act of curing the framed plurality of aggregate particles comprises radiating the framework using ultraviolet light. In some embodiments, the method may further comprise vibrating the plurality of frameworks. In some embodiments, the method may further comprise removing a mobile phase from the framework, wherein the mobile phase comprises depleted cementation reagents. In some embodiments, the method may further comprise controlling a growth time for the at least one biological organism or enzyme in the body before feeding a dose of calcium ion to the framed plurality of aggregate particles. In some embodiments, the method may further comprise controlling a concentration and/or a feeding rate of a dose of calcium to the framed plurality of aggregate particles.

In some embodiments, aggregate particles can be roughed by mixing particles together in a mixer or blender with sufficient force to create cracks in and crevices on particle surfaces, by adding ball bearings or another substance to the aggregate particles with a hardness equal to or greater than the particles themselves, by passing particles over a roughening agent such as, for example, sand, steel, or industrial diamonds, or another roughening agent known to those skilled in the art or combinations thereof.

A temperature, humidity, and/or pH of a framed plurality of aggregate particles can monitored and controlled during the reaction that forms the construction material. The act of forming bridging calcium carbonate crystals between at least two members of the framed plurality of aggregate particles may comprise at least one biological organism or enzyme further comprising urease or cells of a urease-producing microorganism. The act of forming bridging calcium carbonate crystals between at least two members of the framed plurality of aggregate particles may comprise an acid-producing enzyme or cells of an acid-producing microorganism and/or carbonic anhydrase or cells of a carbonic anhydrase-producing microorganism.

Urease-producing microorganisms can comprise but are not limited to Sporosarcina pasteurii, Sporosarcina ureae, Proteus vulgaris, Bacillus sphaericus, Myxococcus xanthus, Proteus mirabilis, Bacillus megaterium, Helicobacter pylori, and combinations of two or more thereof. In some embodiments, the cells comprise spores. Biocementation reagents can further comprise nutrients which promote the growth or enzymatic activities of microorganisms. In some embodiments, the nutrients comprise one or more of salts, amino acids, proteins, peptides, carbohydrates, saccharides, polysaccharides, fatty acids, oil, vitamins, and minerals.

Cementation reagents can comprise a calcium source. Cementation reagents can comprise a urea source. Cementation reagents comprise calcium carbonate. Biocementation reagents comprise calcium chloride. Cementation reagents can comprise cells of a urease-producing microorganism. In some embodiments, the urea-producing microorganism is selected from the group of: Pseudomonas, Delaya avenusta, Thiosphaera pantotropha, Pseudomonas stutzen, Fragilaria crotonensis, Pseudoalteromonas spp., Pseudoalteromonas haloplanktis, Halomonas venusta, Pseudomonas balearica, Pseudomonas stutzeri, Bacillus megaterium, Exiguobacterium aurantiacum, Pseudoalteromonas aliena, Pseudoalteromonas luteoviolacea, E. coli, and variants, serotypes, mutations, recombinant forms, and combinations thereof. In some embodiments, the acid-producing microorganism is selected from the group consisting of: Variovorax, Klebsiella, Pseudomonas, Bacillus, Exiguobacterium, Microbacterium, Curtobacterium, Rathayibacter, CellFimi 2, Streptomyces, Raoultella, B. pumilus, B. safanensis, B. simplex, B. licheniformis, and combinations thereof.

In some embodiments, the acid produced by the acid-producing enzyme of the cells of the acid-producing microorganism is a carboxylic acid. In some embodiments, the acid produced by the acid-producing enzyme of the cells of the acid-producing microorganism is acetic acid, formic acid, propionic acid, butyric acid, gluconic acid, succinic acid, lactic acid, or citric acid. In some embodiments, the method further comprises compacting the mixture to reduce the average linear distance between adjacent aggregate particles by at least about 25%. In some embodiments, the method further comprises compacting the mixture to produce an absolute packing efficiency of the aggregate particles of at least about 50%.

In some embodiments, the method further comprises compacting the mixture by placing the mixture in a vibratory press and applying pressure and vibration to reduce the volume of empty space between a plurality of aggregate particles. In some embodiments, the vibratory motor of the press is operated at a rotational speed from about 100 RPM to about 7200 RPM. In some embodiments, the vibratory motor of the press is operated at a duty cycle from 0.01% to about 100%. In some embodiments, the vibration and pressure are applied simultaneously. In some embodiments, the vibration and pressure are applied alternatively. In some embodiments, the produced construction material comprises at least about 2% calcium carbonate by weight. In some embodiments, the finished construction material comprises at most about 20% calcium carbonate by weight.

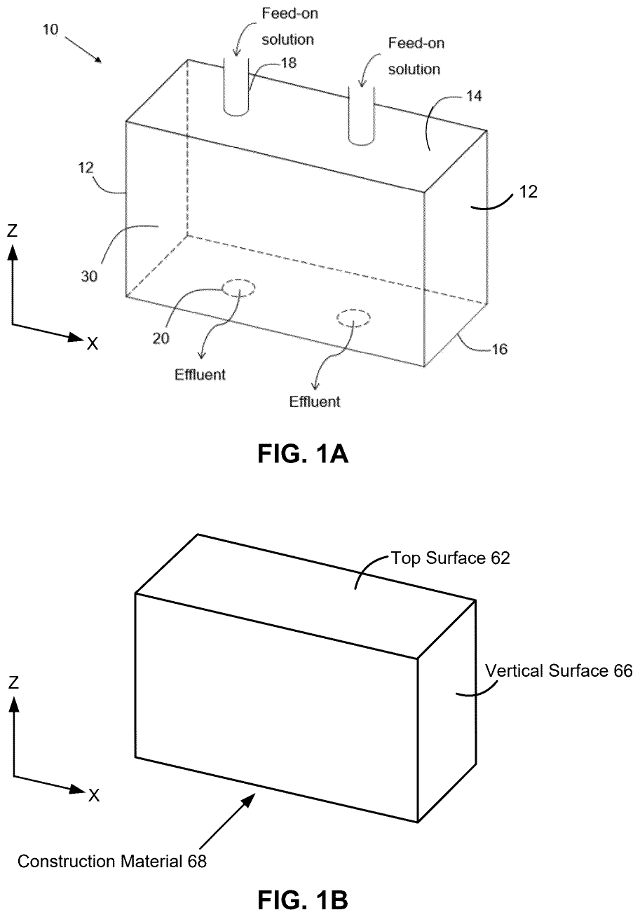

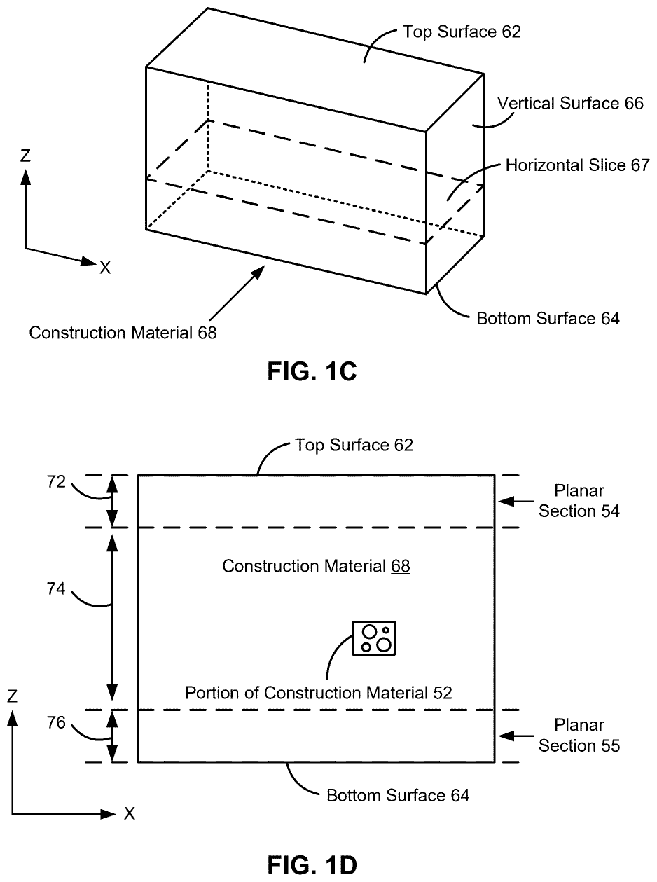

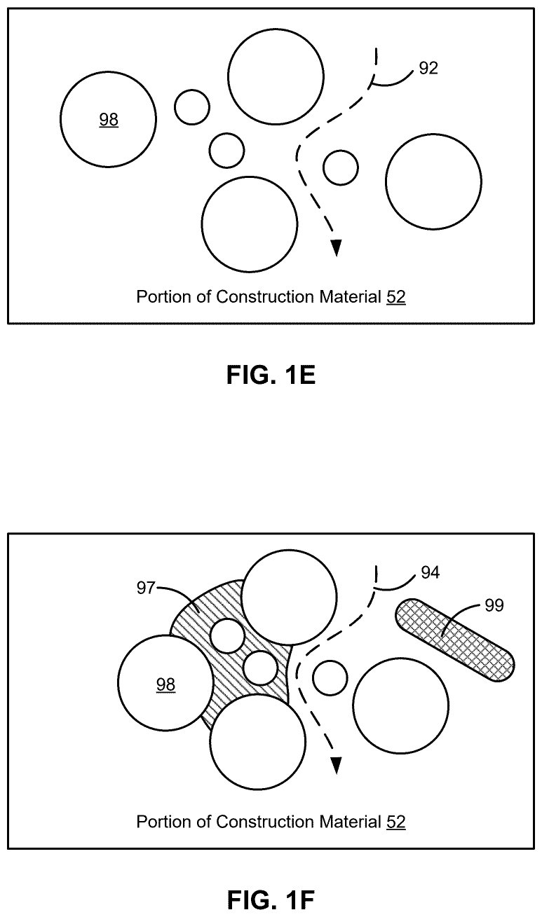

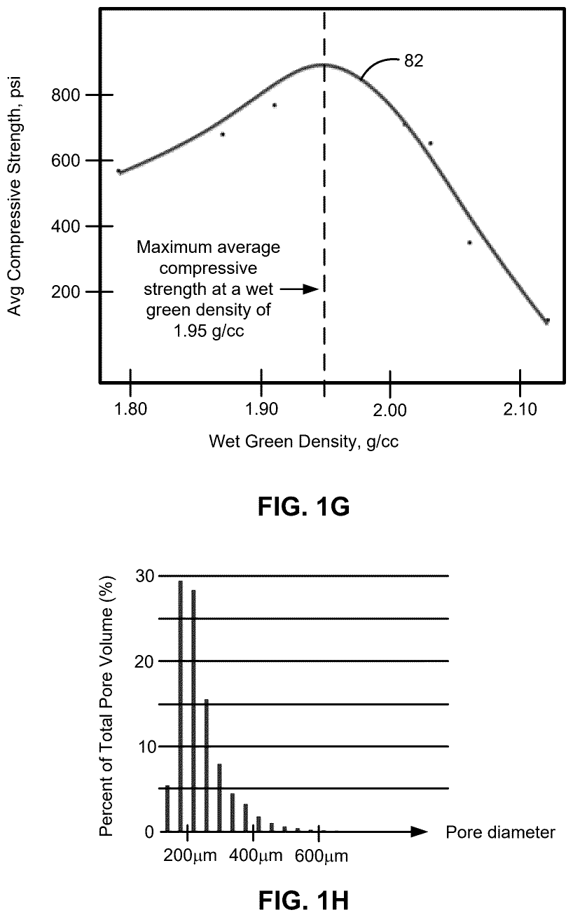

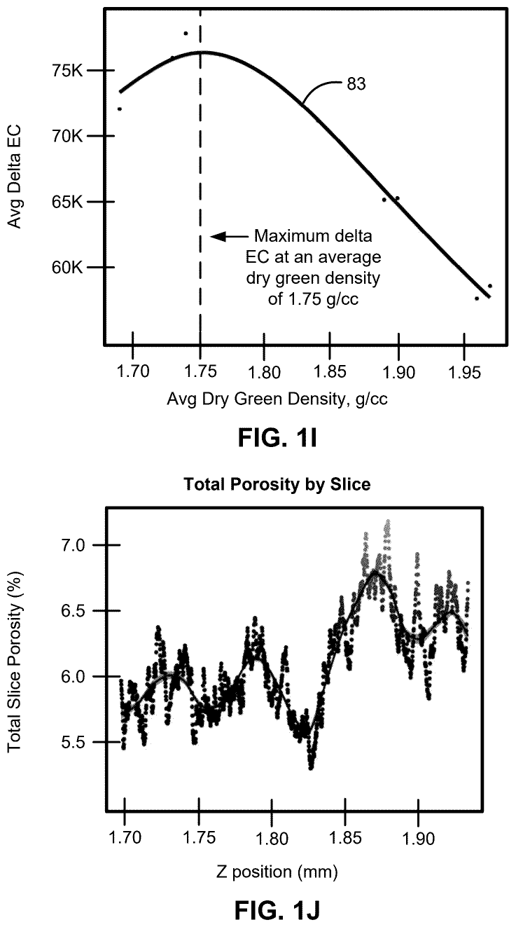

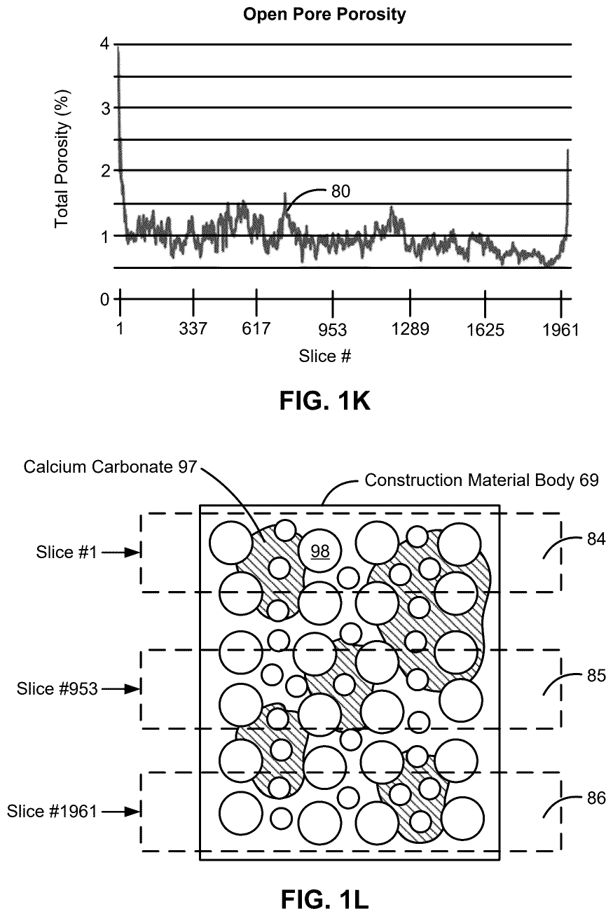

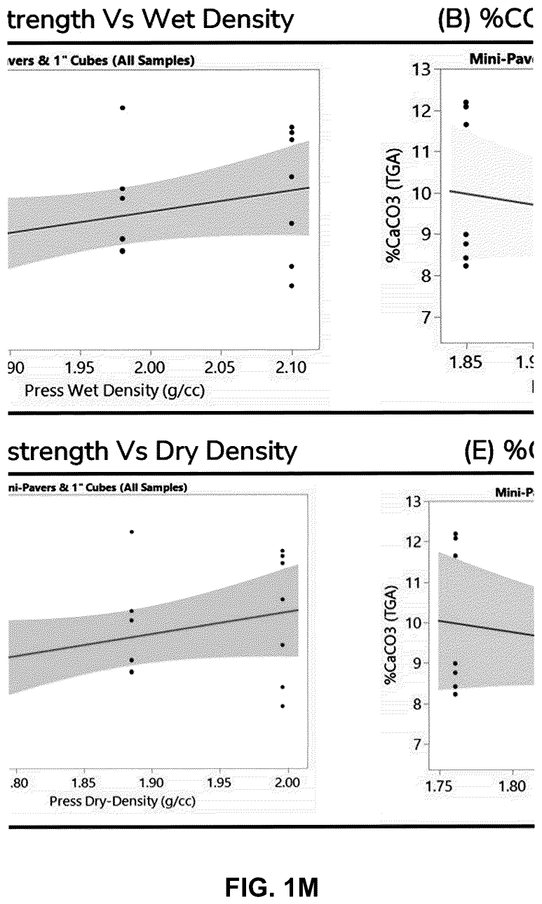

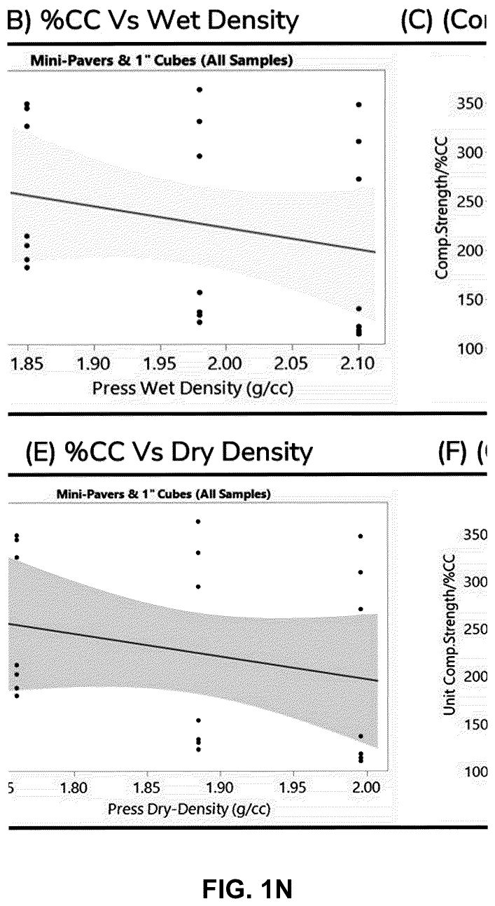

FIG. 1A depicts one embodiment of a formwork 10. In some cases, the formwork 10 may comprise a temporary structure, mold, or container for forming a plurality of aggregate particles. The formwork 10 contains aggregate materials, such as sand or other solid objects of the selected sizes, while the aggregate is being treated with a feed-on solution containing microbe organisms (e.g., enzyme producing bacteria), and/or enzymes (e.g., urease), and/or calcium ions, and/or urea, and/or other nutrients or ingredients. In one example, the urease is formed by exposing an amount of urea to the enzyme producing bacteria, such as Sporosarcina pasteurii.Formwork 10 comprises four vertical walls 12, a top panel 14, and a bottom panel 16, all of which are connected to form a cavity 30 therebetween. On the top panel 14 there are multiple inlets 18 for the feed-on solution (influent) to be fed into the cavity 30. On the bottom panel there are multiple outlets 20 for the effluent to leave the cavity 30.

In some embodiments, the feed-on solution may be delivered to the cavity 30 or material within the cavity 30 via a feed source or feed distribution system. The feed distribution system may utilize a spray or drip mechanism to distribute the feed-on solution.

The cavity 30 is adapted to receive the loose pieces of aggregate such as sand. Some, if not all, panels are removable to facilitate the removal of contents (e.g., the brick) from the cavity 30. The vertical walls 12 or at least the inside surfaces thereof, may be made of a non-reactive, non-porous material such as cast or extruded acrylic resin. Additional sensors (e.g., temperature sensors, oxygen sensors, calcium ion sensor, carbon dioxide sensor, cameras, etc.) may be installed to monitor the conditions inside or around the cavity 30. The addition or draining of the feed-on solution can be controlled in part based on the data obtained by the sensors. The conditions and/or speed of introducing the feed-on solution can be controlled in part based on the data obtained by the sensors.

When the process starts, the aggregate materials are laid into the cavity either in layers or in portions. The aggregate materials have been filtered by an aggregate filter to select the sizes of the aggregates to be fed into the cavity 30. Then the top panel 14 is placed on top of the aggregate materials and seal the cavity 30. Feed-on solution is introduced into the cavity through the multiple inlets 18. The compositions of the feed-on solution can be changed over time. The temperature of the feed-on solution before entering the cavity 30 can be controlled by a heat-exchange module to either heat up or cool down the feed-on solution to the desired temperature. The speed to introduce the feed-on solution is controlled by a pump or other mechanisms. The multiple outlets 20 are closed or partially closed when the feed-on solution is introduced into the cavity 30. When the multiple outlets 20 are opened, effluent can be drained off from the cavity 30. An optional mechanical stirrer can be installed inside cavity 30 or a shaker can be used to agitate the contents in the cavity 30. The feeding and draining of the feed-on solution can be repeated multiple times. The time length between the feeding and draining of the feed-on solution can vary, including but not limited to, a minute, ten minutes, tens of minutes, an hour, several hours, half a day, a day, a day and a half, two days, or other time periods. Additional inlets and/or outlets may be available around the body the framework 10 (e.g., on the vertical walls 12).

After the last run of feed-on solution as a bath for the aggregate materials, all the remaining solution in the cavity 30 is removed. Optionally a washing solution is introduced into the cavity 30 to rinse the formed product (e.g., the brick) and/or to kill the remaining organisms. Optionally air or inert air is introduced through the inlets, blow through the cavity 30, and exit through the outlets 20. This air treatment can be added between the feed-on solution/bath incubations to blow away or loosen coatings on the top surface. Such coatings on the top surface may block pores through which the feed-on solution can enter the body/internal portions of the aggregates/brick. At the end of the bath treatment, the formed product is then removed from the cavity 30 and tested/stored. For example, layers with different depth from the top surface of the brick can be prepared and analyzed by scanning electron microscope (SEM) or other analytic methods. For example, the brick can be cut at different depth from the top surface of the brick. Properties, such as, chemical entities, porosity, water absorption capacity, size distribution of the aggregate particles inside the brick, mechanical strength, etc., of each layer can be obtained, compared, and correlated with each other and the process conditions. In this way, the parameters of the bath-treatment and/or the ingredients of the feed-on solution can be adjusted to improve the properties of the formed products (e.g., bricks).

As depicted in FIG. 1A, the vertical walls 12 extend in a first direction (e.g., the Z direction), the top panel 14 extends in a second direction orthogonal to the first direction, and the bottom panel 16 extends in the second direction (e.g., the X direction).

FIG. 1B depicts one embodiment of a cross-sectional view of a construction material 68. The construction material 68 may include a plurality of aggregate particles. The construction material 68 has a top surface 62 and a bottom surface 64 opposite to the top surface 62. A vertical surface 66 may connect or be orthogonal to the top surface 62 and the bottom surface 64. In one embodiment, the construction material 68 may be formed or created using the formwork 10 depicted in FIG. 1A. The construction material 68 may be formed within the cavity 30 of the formwork 10. In this case, the top surface 62 may correspond to a first surface that abutted the top panel 14 and the bottom surface 64 may correspond to a second surface that abutted the bottom panel 16 depicted in FIG. 1A. The top surface 62 may comprise a non-preferred surface that is closest to the multiple inlets 18 into which the feed-on solution is provided to the construction material. The depth of the vertical walls 12 in FIG. 1A may correspond to the depth or thickness of the construction material 68.

As depicted in FIG. 1B, the vertical surface 66 extends in a first direction (e.g., the Z direction), the top surface 62 extends in a second direction orthogonal to the first direction, and the bottom surface 64 extends in the second direction (e.g., the X direction).

FIG. 1C depicts one embodiment of a cross-sectional view of the construction material 68 shown in FIG. 1B with a horizontal slice 67 cut through the construction material 68 and extending in the second direction (e.g., the X direction). The horizontal slice 67 may have a material thickness (e.g., a thickness of 0.1 mm to 10 cm, e.g., 0.1 mm to 1 mm, 1 mm to 2 mm, 1 mm to 5 mm, 1 mm to 1 cm, e.g., 1 cm to 2 cm, 1 cm to 5 cm, or 1 cm to 10 cm, e.g., about 0.1 mm, 0.5 mm, 1 mm, 1.5 mm, 2 mm, 5 mm, 1 cm, 2 cm, or 10 cm) and thus may comprise a planar section that extends in the second direction.

FIG. 1D depicts one embodiment of a side view of the construction material 68 shown in FIG. 1B. As depicted in FIG. 1D, a first planar section 54 of the construction material 68 that abuts the top surface 62 has a first thickness 72 and a second planar section 55 of the construction material 68 that abuts the bottom surface 64 has a second thickness 76. The first thickness 72 may be substantially the same as the second thickness 76. In one example, the first thickness 72 may comprise 1.2 cm and the second thickness 76 may comprise 1.1 cm. A third thickness 74 of a middle planar section of the construction material 68 arranged between the first planar section and the second planar section may be determined based on a height of the construction material 68 minus the first thickness 72 and the second thickness 74. The height of the construction material 68 may correspond to the height of the vertical surface 66. The vertical surface 66 of the construction material 68 may comprise a vertical wall that connects the top surface 62 to the bottom surface 64.

Referring to the construction material 68 depicted in FIGS. 1B-1D, the top surface 62 may be parallel with the bottom surface 64. The top surface 62 may be substantially opposite the bottom surface 64. The vertical surface 66 may comprise one of a number of vertical walls (or walls) that are between the top surface 62 and the bottom surface 64. The vertical surface 66 may structurally connect (or connect) the top surface 62 and the bottom surface 64. A material body of the construction material 68 may encompass or enclose the top surface 62, the vertical surface 66, and the bottom surface 64. The top surface 62, the vertical surface 66, and the bottom surface 64 may comprise outer surfaces of the material body of the construction material 68.

As depicted in FIG. 1D, the construction material 68 includes a portion 52 of the construction material 68 that is enlarged in FIGS. 1E-1F.

FIG. 1E depicts one embodiment of aggregate particles within the construction material 68 of FIG. 1D prior to compression. FIG. 1F depicts one embodiment of aggregate particles within the construction material 68 of FIG. 1D after compression of the aggregate particles. The aggregate particles include aggregate particle 98, which may comprise a particle of sand or gravel. As depicted in FIGS. 1E-1F, the size of the pore space between the aggregate particles has reduced due to compression of the aggregate particles. Porosity may refer to the pore space volume within a planar section of the construction material 68 divided by the total volume of the planar section. The path of fluid flow 92 is less restrictive than the path of fluid flow 94 due to compression occurring within the construction material.

As depicted in FIG. 1F, a biological organism 99 has produced an environment in which calcium carbonate 97 has formed to structurally connect some of the aggregate particles including aggregate particle 98.

Due to compression of the construction material, the porosity has been reduced as well as the spacing between the aggregate particles. With concrete, increased aggregate density correlates with improved compressive strength; however, increased aggregate density also reduces pore space. One technical issue with biocement products and construction materials that include biocement is that smaller pore sizes lead to less space to hold bacteria and less space to hold feed for the bacteria. Moreover, narrower pore throats caused by smaller pore sizes may lead to reduced flow of feed through the construction material. The combination of less space to hold bacteria, less space to hold feed for the bacteria, and reduced flow of feed may lead to less bridging calcium carbonate within the construction material and to reduced compressive strength.

FIG. 1G depicts one embodiment of experimental results 82 showing the average compressive strength (in psi) for a construction material over a range of wet green densities (in g/cc) for the construction material prior to the formation of bridging calcium carbonate and/or other binding agents within the construction material. As depicted in FIG. 1G, the average compressive strength of the construction material when in a finished product state varies with the wet green density of the construction material prior to application of biocementation processes. As depicted, a wet green density of 2.10 g/cc provides an average compressive strength of 180 psi, a wet green density of 1.80 provides an average compressive strength of 590 psi, and a wet green density of 1.95 provides the highest average compressive strength of 850 psi. The maximum average compressive strength of the construction material occurs when the wet green density is 1.95 g/cc. The wet green density of the construction material prior to the application of biocementation processes may have a significant impact on the resulting average compressive strength of the construction material. The construction materials tested in this experiment were fed with multiple static feed solutions, eliminating confounding variables associated with flow-through feeding.

FIG. 1H depicts one embodiment of a graph showing the percentage of total pore volume vs pore diameter for a construction material. As depicted, most pores within the construction material have diameters that are between 170 mm and 300 mm, with a pore diameter close to 200 mm being the most common pore diameter size.

FIG. 1I depicts one embodiment of experimental results 83 showing the average change in electrical conductivity (or delta EC) for a construction material over a range of average dry green densities (in g/cc) for the construction material. The average change in electrical conductivity is one metric for measuring how fast a biocementation process is proceeding. The amount of cementation reagents consumed in a feed cycle varies with the green density of the construction material. As depicted, the maximum average delta EC occurs with an average dry green density of close to 1.75 g/cc. The construction materials tested in this experiment were fed with multiple static feed solutions, eliminating confounding variables associated with flow-through feeding.

FIG. 1J depicts one embodiment of a graph showing the total slice porosity over horizontal slice position from a non-preferred surface of a construction material. In reference to FIG. 1C, horizontal slice 67 comprises a horizontal slice through the construction material 68. As depicted, horizontal slices through the construction material from 1.7 mm to 1.8 mm from the non-preferred surface of the construction material has a total slice porosity of about 6%.

FIG. 1K depicts one embodiment of experimental results 80 showing total open pore porosity vs slice number through a construction material. FIG. 1L depicts one embodiment of a construction material body 69 that comprises aggregate particles including aggregate particle 98 that have been bound together using calcium carbonate including calcium carbonate 97. As depicted, a first horizontal slice 84 (Slice #1) comprises the top-most slice through the construction material body 69, a second horizontal slice 85 (Slice #953) comprises an internal slice through the construction material body 69, and a third horizontal slice 86 (Slice #1961) comprise the bottom-most slice through the construction material body 69. The total open pore porosity for the second horizontal slice 85 (Slice #953) is close to 1%. The total open pore porosity for the first horizontal slice 84 (Slice #1) and the third horizontal slice 86 (Slice #1961) are greater than 2%.

FIG. 1M depicts one embodiment of experimental results showing compressive strength vs wet green density and compressive strength vs dry green density for a construction material. The construction materials tested in this experiment were fed in a manual flow-through feeding system.

FIG. 1N depicts one embodiment of experimental results showing percentage of calcium carbonate formed (measured by TGA) vs wet green density and percentage of calcium carbonate vs dry green density for a construction material. The construction materials tested in this experiment were fed in a manual flow-through feeding system.

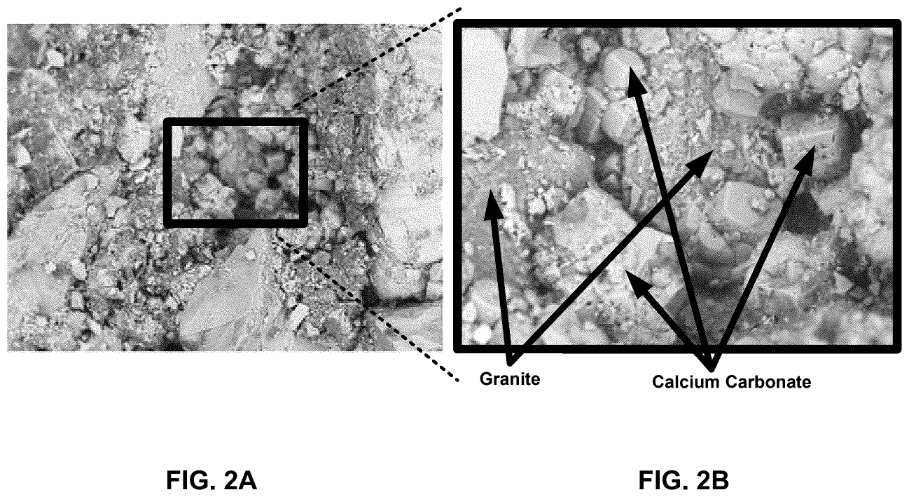

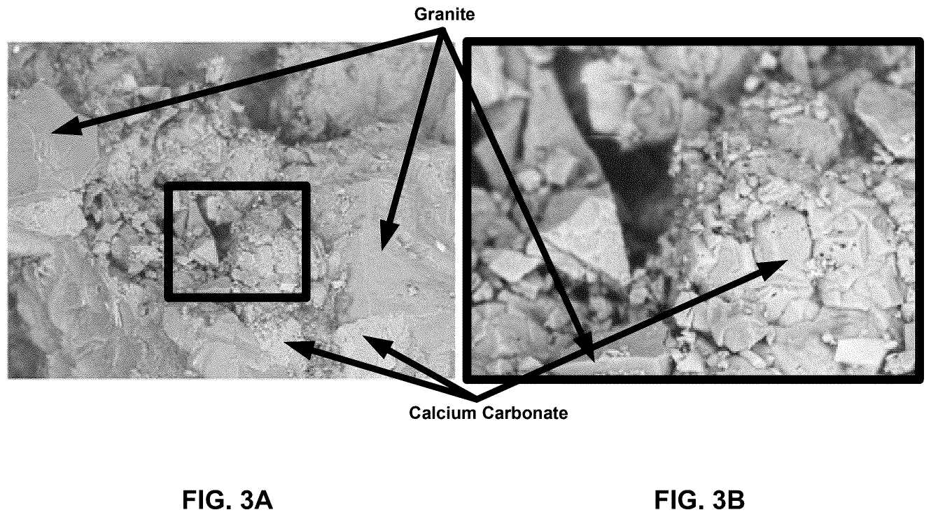

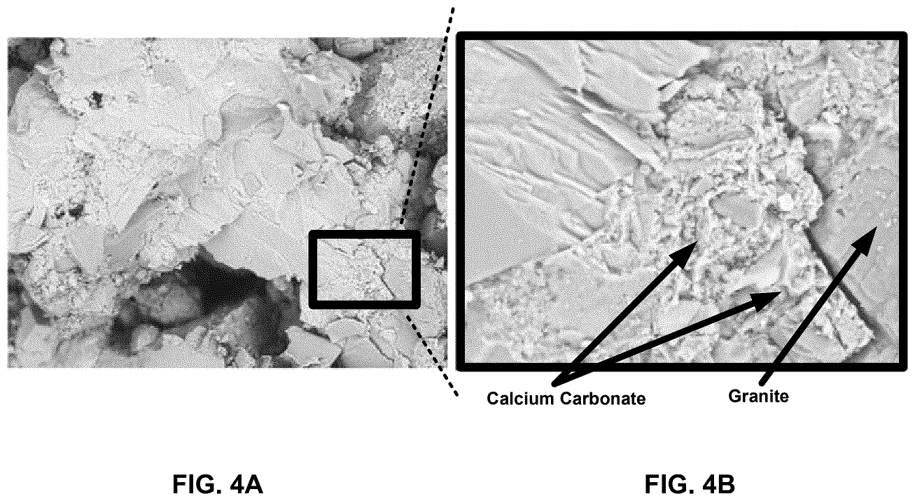

FIGS. 2A-2B shows the SEM images taken on the top surface layer of the final product (brick). The areas in the images corresponding to granite and calcium carbonate are shown. FIG. 2A shows an area with a block that is magnified and shown in FIG. 2B. FIGS. 3A-3B shows the SEM images taken on a top middle layer (approximated 3-5 millimeter below the top surface layer shown in FIGS. 2A-2B) of the final product (brick). The areas in the images corresponding to granite and calcium carbonate are shown. FIG. 3A shows an area within a block that is magnified and shown in FIG. 3B. FIGS. 4A-4B show the SEM images taken on a bottom middle layer (approximated 8-10 millimeter below the top middle surface layer shown in FIGS. 3A-3B) of the final product (brick). The areas in the images corresponding to granite and calcium carbonate are shown. FIG. 4A shows an area within a block that is magnified and shown in FIG. 4B. SEM/EDX analysis on different layers from bricks obtained from different batches (hence, different feed-on solution batch conditions) can be conducted and compared.

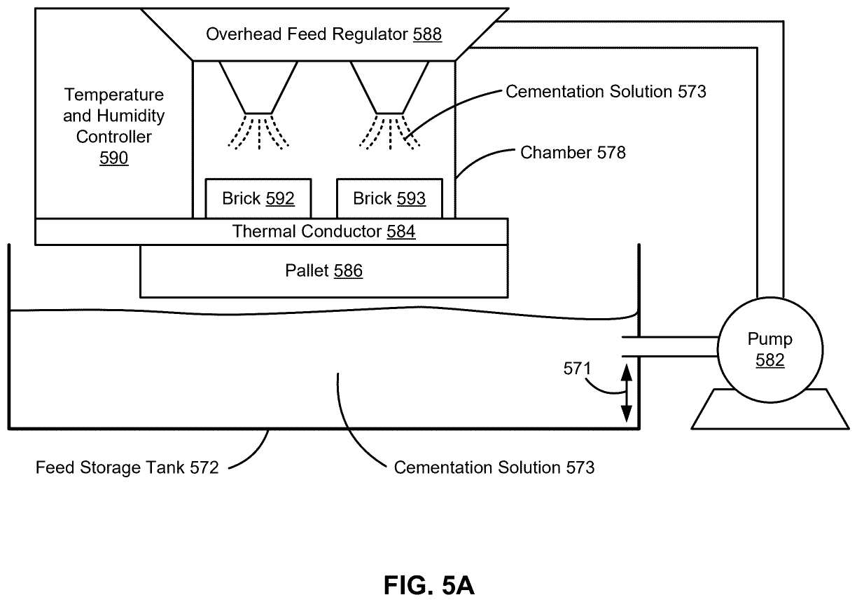

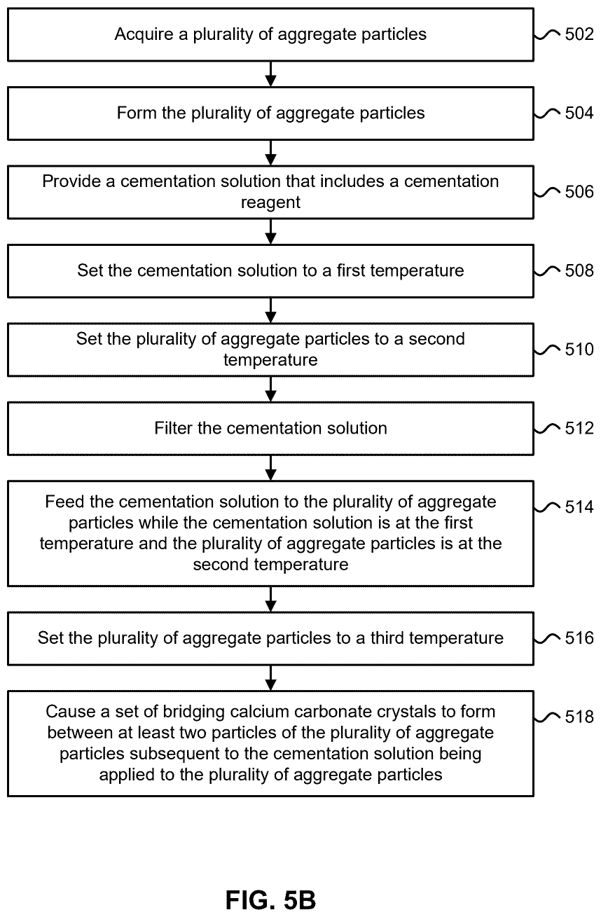

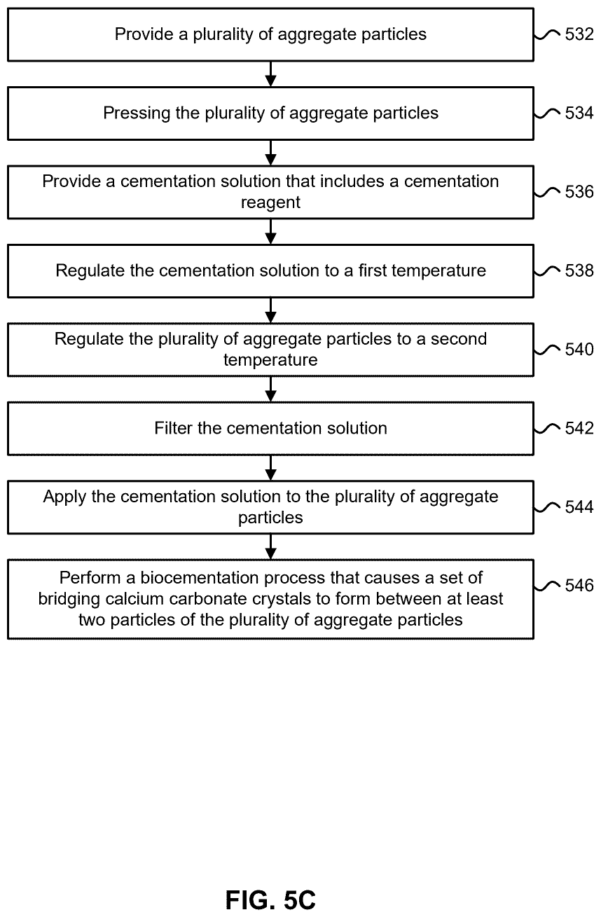

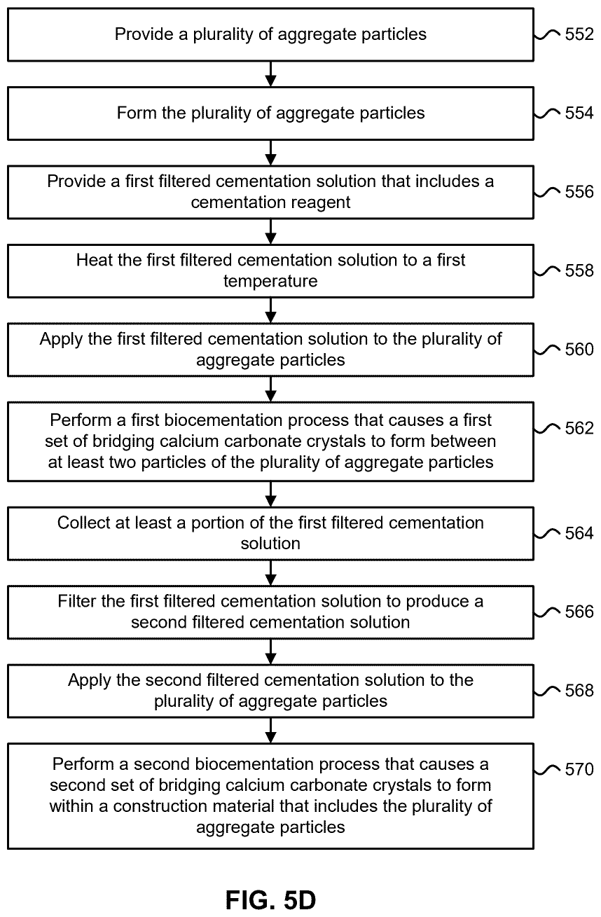

FIG. 5A depicts one embodiment of a system for manufacturing a construction material using one or more biocementation processes. The system includes a chamber 578 for processing a construction material. As depicted, the construction material includes a brick 592 and a brick 593. Although two bricks are depicted, other construction materials may also be utilized such as tiles and blocks. The system also includes an overhead feed regulator 588 for applying a cementation solution 573 to the construction material within the processing chamber 578. The overhead feed regulator 588 may regulate a temperature of the cementation solution applied to the construction material within the processing chamber 578 and regulate the rate at which the cementation solution is applied to the construction material. The overhead feed regulator 588 may include a heating element and/or a cooling element for regulating the temperature of the cementation solution applied to the construction material. The system also includes a temperature and humidity controller 590 connected to a thermal conductor 584 (e.g., a metal grating or metal strip) that is in thermal communication with the bricks 592-593 within the chamber 578. The thermal conductor 584 may be directly connected to or physically contact the bricks 592-593. A pallet 586 provides structural support for the construction material within the chamber 578. The thermal conductor 584 is arranged between the pallet 586 and the chamber 578.

In some embodiments, the temperature and humidity controller 590 may regulate the temperature of the construction material within the chamber 578 via the heating or cooling of the thermal conductor 584. The temperature and humidity controller 590 may regulate or adjust the temperature of the construction material within the chamber 578 using temperature regulated air flow. The chamber 578 may fully enclose the construction material or may provide an open or vented environment.

In some embodiments, the temperature and humidity controller 590 may include a computing system. The computing system may include a network interface, processor, memory, and disk all in communication with each other. The network interface, processor, memory, and disk may comprise real components or virtualized components. In one example, the network interface, processor, memory, and disk are provided by a virtualized infrastructure or a cloud-based infrastructure. The network interface may allow the computing system to connect to one or more networks. As examples, the network interface may comprise a wireless network interface and/or a wired network interface. The processor may allow the computing system to execute computer readable instructions stored in memory in order to perform processes described herein. The processor may include one or more processing units, such as one or more CPUs, one or more GPUs, and/or one or more NPUs. The memory may comprise one or more types of memory (e.g., RAM, SRAM, DRAM, EEPROM, Flash). The disk may include a hard disk drive and/or a solid-state drive. In some cases, both the memory and disk may comprise hardware storage devices.

As depicted in FIG. 5A, the system for manufacturing a construction material using one or more biocementation processes also includes a feed storage tank 572 for collecting left over portions of the cementation solution 573. The left over or unused portions of the cementation solution 573 that passed through the construction material or were not utilized by the construction material during a biocementation process may be collected and reused during subsequent biocementation processes. The filtered and/or recycled cementation solution 573 may be transferred to the overhead feed regulator 588 via a pump 582. In some cases, particulate matter within the cementation solution 573 collected by the feed storage tank 572 may be allowed to settle within the collection tank and therefore intaking fluid away from the bottom of the collection tank may provide filtering of the recycled cementation solution 573. In one example, the inlet tube for providing recycled cementation solution 573 to the pump 582 may be arranged at least 10 inches from the bottom of the feed storage tank 572 (e.g., the distance 571 between the bottom of the feed storage tank 572 and the inlet tube may be 12 inches). The inlet tube may include additional filtering for removing particulates from the recycled cementation solution 573.

In one embodiment, the temperature of the cementation solution 573 that is applied to the top of the bricks 592-593 may be less than the temperature applied to the bottom of the bricks 592-593 in order to reduce the rate of biocement formation for portions of the bricks 592-593 that are closer to the top of the bricks 592-593 to which the cementation solution 573 is applied. In one example, the temperature of the cementation solution 573 that is applied to the top of the bricks 592-593 and the temperature applied to the bottom of the bricks 592-593 via the thermal conductor 584 may be set such that the top 1 cm of the bricks 592-593 has a rate of biocement formation that is at least 20% to 50% slower than the rate of biocement formation for the bottom 1 cm of the bricks 592-593 closest to the thermal conductor 584.

FIG. 5B depicts a flowchart describing one embodiment of a process for producing a construction material. In one embodiment, the process of FIG. 5B is performed using the formwork depicted in FIG. 1A. In some embodiments, the process of FIG. 5B is performed using the system for manufacturing a construction material depicted in FIG. 5A.

In step 502, a plurality of aggregate particles is acquired. The plurality of aggregate particles may be provided from a mix of aggregate materials. The aggregate materials may include sand, gravel, and/or granular materials. In step 504, the plurality of aggregate particles is formed or shaped. In one example, the plurality of aggregate particles is formed using a press to compact the plurality of aggregate particles or to form the plurality of aggregate particles into a desired shape for a finished biocement product.

In step 506, a cementation solution that includes a cementation reagent is provided. The cementation reagent may be used to promote calcite precipitation to form bonds between aggregate particles within the plurality of aggregate particles. The cementation solution may be stored within the overhead feed regulator 588 in FIG. 5A. In step 508, the cementation solution is set to a first temperature. The cementation solution may be set and maintained at the first temperature using a heating plate or heat exchange system within the overhead feed regulator 588. In step 510, the plurality of aggregate particles is set to a second temperature. In one embodiment, the first temperature is less than the second temperature. In another embodiment, the first temperature is greater than the second temperature. The plurality of aggregate particles may be set to the second temperature via direct physical contact with a heating element or a thermal conductor, such as the thermal conductor 584 in FIG. 5A.

In step 512, the cementation solution is filtered. In some cases, a filter may be provided within the overhead feed regulator 588 in FIG. 5A. The filter may comprise a particulate filter or a biofilter. In other cases, the feed storage tank 572 may provide filtering as particulate matter within the collected cementation solution may be allowed to settle at the bottom of the feed storage tank 572 and the inlet tube for recycling the cementation solution from the feed storage tank 572 may be positioned to capture filtered liquid a threshold distance away from the bottom of the feed storage tank 572.

In step 514, the cementation solution is fed to or applied to the plurality of aggregate particles. The cementation solution may be fed to or applied to the plurality of aggregate particles while the cementation solution is at the first temperature and the plurality of aggregate particles is at the second temperature. In some cases, the temperature of the cementation solution is set such that a liquid for delivering the cementation reagent is less than the temperature of the plurality of aggregate particles or is less than the temperature of a bottom planar section of the plurality of aggregate particles. In some cases, the temperature of the cementation solution is set such that it is less than the temperature of the plurality of aggregate particles by at least a threshold amount (e.g., the temperature of the cementation solution is at least 20 degrees cooler than the temperature of the plurality of aggregate particles). In some cases, a bottom surface of a construction material comprising the plurality of aggregate particles is set to a second temperature that is greater than the first temperature of the cementation reagent added to the plurality of aggregate particles.

In step 516, the plurality of aggregate particles is set to a third temperature. The plurality of aggregate particles may be set to a third temperature greater than the second temperature after the cementation solution has been applied to the plurality of aggregate particles. In step 518, bridging calcium carbonate crystals are formed between at least two particles of the plurality of aggregate particles. The bridging calcium carbonate crystals may be formed while the temperature of the cementation solution is less than the temperature of the plurality of aggregate particles. The bridging calcium carbonate crystals may be formed subsequent to the cementation solution being applied to the plurality of aggregate particles.

FIG. 5C depicts a flowchart describing an alternative embodiment of a process for producing a construction material. In one embodiment, the process of FIG. 5C is performed using the formwork depicted in FIG. 1A. In some embodiments, the process of FIG. 5C is performed using the system for manufacturing a construction material depicted in FIG. 5A.

In step 532, a plurality of aggregate particles is provided. In step 534, the plurality of aggregate particles is pressed and/or formed. In step 536, a cementation solution that includes a cementation reagent is provided. The cementation solution may be stored within a heated container with an overhead feed regulator, such as the overhead feed regulator 588 in FIG. 5A. In step 538, the cementation solution is regulated to a first temperature. The cementation solution may be regulated using temperature control circuitry within the temperature and humidity controller 590 in FIG. 5A that is in communication with a heat exchanger or a heat plate within the overhead feed regulator. In step 540, the plurality of aggregate particles is regulated to a second temperature. In one example, the plurality of aggregate particles may correspond with brick 592 in FIG. 5A and a bottom portion of the brick 592 in thermal communication with the thermal conductor 584 may be set to or regulated to the second temperature via a temperature of the thermal conductor 584. In step 542, the cementation solution is filtered. In step 544, the cementation solution is applied to the plurality of aggregate particles. In some cases, the filtered cementation solution may be applied to the plurality of aggregate particles using a drip or spray system. In step 546, a biocementation process is performed. The biocementation process may cause a set of bridging calcium carbonate crystals to form between at least two particles of the plurality of aggregate particles.

FIG. 5D depicts a flowchart describing an alternative embodiment of a process for producing a construction material. In one embodiment, the process of FIG. 5D is performed using the formwork depicted in FIG. 1A. In some embodiments, the process of FIG. 5D is performed using the system for manufacturing a construction material depicted in FIG. 5A.

In step 552, a plurality of aggregate particles is provided or acquired. In step 554, the plurality of aggregate particles is formed and/or pressed. In step 556, a first filtered cementation solution is provided. The first filtered cementation solution includes a cementation reagent. In step 558, the first filtered cementation solution is heated to a first temperature. In step 560, the first filtered cementation solution is applied to the plurality of aggregate particles. The first filtered cementation solution may be applied to the plurality of aggregate particles while the first filtered cementation solution is regulated to the first temperature. In step 562, a first biocementation process is performed. The first biocementation process causes a first set of bridging calcium carbonate crystals to form between at least two particles of the plurality of aggregate particles. In step 564, at least a portion of the first filtered cementation solution is collected (e.g., within the feed storage tank 572 in FIG. 5A). In step 566, the first filtered cementation solution is filtered to produce a second filtered cementation solution. In step 568, the second filtered cementation solution is applied to the plurality of aggregate particles. In step 570, a second biocementation process is performed. The second biocementation process causes a second set of bridging calcium carbonate crystals to form within a construction material that includes the plurality of aggregate particles.

At least one embodiment of the disclosed technology includes a construction material comprising: (a) a plurality of aggregate particles; (b) bridging calcium carbonate crystals between at least two members of the plurality of aggregate particles; (c) non-bridging calcium carbonate crystals; and (d) at least one biological organism or enzyme producing at least some of the bridging calcium carbonate crystals, wherein the construction material comprises at least one surface and a body enclosed by the at least one surface, and wherein (i) a first average concentration of the non-bridging calcium carbonate crystals at or near the at least one surface is no more than a second average concentration of the bridging calcium carbonate crystals at or near the at least one surface, or (ii) the second average concentration differs no more than 70% from a third average concentration of the bridging calcium carbonate crystals at or near a cross-section of the body.

In some cases, the first average concentration is no more than the second average concentration.

In some cases, the first average concentration is no more than 99%, 95%, 90%, 85%, 80%, 75%, 70%, 65%, or 60% of the second average concentration.

In some cases, the second average concentration differs no more than 50% from the third average concentration.

In some cases, the second average concentration differs no more than 69%, 65%, 60%, 55%, 50%, 45%, 40%, 35%, 30%, 25%, 20%, 15%, or 10% from the third average concentration.

In some cases, the second average concentration differs no more than 50% from the third average concentration. The second average concentration differs no more than 49%, 45%, 40%, 35%, 30%, 25%, 20%, 15%, or 10% from the third average concentration.

In some cases, the first average concentration differs no more than 70% from a fourth average concentration of the non-bridging calcium carbonate crystals at or near the cross-section of the body.

In some cases, the first average concentration differs no more than 69%, 65%, 60%, 55%, 50%, 45%, 40%, 35%, 30%, 25%, 20%, 15%, or 10% from the fourth average concentration.

In some cases, the at least one biological organism or enzyme comprises urease or cells of a urease-producing microorganism.

In some cases, the at least one biological organism or enzyme comprises an acid-producing enzyme or cells of an acid-producing microorganism.

In some cases, the at least one biological organism or enzyme comprises carbonic anhydrase or cells of a carbonic anhydrase-producing microorganism.

In some cases, the at least one biological organism or enzyme comprises a urea-producing microorganism.

In some cases, an average compression strength of the construction material is at least about 1,500 pound per square inch (psi).

In some cases, the average compression strength is at least about 1,500, 1,600, 1,700, 1,800, 1,900, 2,000, 2,200, 2,400, 2,600, 2,800, 2,900, 3,000, 3,200, 3,400, 3,600, 3,800, 4,000, 4,200, 4,400, 4,600, 4,800, 5,000, 5,200, 5,400, 5,600, 5,800, 6,000, 6,200, 6,400, 6,600, or 6,800 psi.

In some cases, the at least one surface comprises a first surface and a second surface, and wherein the first average concentration at or near the first surface differs no more than 50% from the first average concentration at or near the second surface.

In some cases, the first average concentration at or near the first surface differs no more than 49%, 45%, 40%, 35%, 30%, 25%, 20%, 15%, or 10% from the first average concentration at or near the second surface.

At least one embodiment of the disclosed technology includes a construction material comprising: (a) a first surface; (b) a second surface substantially opposite of the first surface; (c) one or more walls between and connecting the first surface and the second surface; and (d) a body enclosed by the first surface, the second surface and the one or more walls; (e) a plurality of aggregate particles; (f) bridging calcium carbonate crystals between at least two members of the plurality of aggregate particles; (g)non-bridging calcium carbonate crystals; and (h) at least one biological organism or enzyme producing at least some of the bridging calcium carbonate crystals, wherein a first average concentration of non-bridging calcium carbonate crystals on the first surface is at least about 10% higher than a second average concentration of non-bridging calcium carbonate crystals on the second surface.

In some cases, the first average concentration is at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 100% higher than the second average concentration.

In some cases, the first average concentration is at least about 10% higher than a third average concentration of non-bridging calcium carbonate crystals at or near a cross-section of the body.

In some cases, the first average concentration is at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 100% higher than the third average concentration.

In some cases, (i) the first average concentration is more than a fourth average concentration of the bridging calcium carbonate crystals at or near the first surface, and/or (ii) the fourth average concentration differs no more than 70% from a fifth average concentration of the bridging calcium carbonate crystals at or near the cross-section of the body.

In some cases, the fourth average concentration differs no more than 69%, 65%, 60%, 55%, 50%, 45%, 40%, 35%, 30%, 25%, 20%, 15%, or 10% of the fifth average concentration.

In some cases, the at least one biological organism or enzyme comprises urease or cells of a urease-producing microorganism.

In some cases, the at least one biological organism or enzyme comprises an acid-producing enzyme or cells of an acid-producing microorganism.

In some cases, the at least one biological organism or enzyme comprises carbonic anhydrase or cells of a carbonic anhydrase-producing microorganism.

In some cases, the at least one biological organism or enzyme comprises a urea-producing microorganism.

In some cases, an average compression strength of the construction material is at least about 1,500 pound per square inch (psi).

In some cases, the average compression strength is at least about 1,500, 1,600, 1,700, 1,800, 1,900, 2,000, 2,200, 2,400, 2,600, 2,800, 2,900, 3,000, 3,200, 3,400, 3,600, 3,800, 4,000, 4,200, 4,400, 4,600, 4,800, 5,000, 5,200, 5,400, 5,600, 5,800, 6,000, 6,200, 6,400, 6,600, or 6,800 psi.

At least one embodiment of the disclosed technology includes a construction material comprising: (a) a first surface; (b) a second surface substantially opposite of the first surface; (c) one or more walls between and connecting the first surface and the second surface; (d) a body enclosed by the first surface, the second surface and the one or more walls, the body comprises a plurality of aggregate particles; (e) calcium carbonate; and (f) at least one biological organism or enzyme producing at least some of calcium carbonate formed between at least two members of the plurality of aggregate particles, wherein a first average weight percentage of calcium carbonate on the first surface differs no more than 50% of a second average weight percentage of calcium carbonate on the second surface.

In some cases, the first average weight percentage differs no more than 50% of a third average weight percentage of calcium carbonate on a cross-section of the body.

In some cases, the first average weight percentage differs no more than 49%, 45%, 40%, 35%, 30%, 25%, 20%, 15%, or 10% of the second average weight percentage.

In some cases, the first average weight percentage differs no more than 49%, 45%, 40%, 35%, 30%, 25%, 20%, 15%, or 10% of the third average weight percentage.

At least one embodiment of the disclosed technology includes a construction material comprising: (a) a first surface; (b) a second surface substantially opposite of the first surface; (c) one or more walls between and connecting the first surface and the second surface; and (d) a body enclosed by the first surface, the second surface and the one or more walls, the body comprises a plurality of aggregate particles; (e) calcium carbonate; and (f) at least one biological organism or enzyme producing at least some of calcium carbonate formed between at least two members of the plurality of aggregate particles, wherein a first average porosity of the construction material is from 15% to 50%.

In some cases, a first average porosity on the first surface differs no more than 50% of a second average porosity on the second surface.

In some cases, the first average porosity differs no more than 49%, 45%, 40%, 35%, 30%, 25%, 20%, 15%, or 10% of the second average porosity.

In some cases, a first average porosity on the first surface differs no more than 50% of a third average porosity on a cross-section of the body.

In some cases, the first average porosity differs no more than 49%, 45%, 40%, 35%, 30%, 25%, 20%, 15%, or 10% of the third average porosity.

In some cases, a first average porosity on the first surface is from 15% to 50%.

In some cases, a second average porosity on the second surface is from 15% to 50%.

In some cases, a third average porosity on a cross-section of the body is from 15% to 50%.

In some cases, the cross-section is at least 3 mm away from the first surface and the second surface.

In some cases, a first average porosity on the first surface is larger than a third average porosity on a cross-section of the body.

In some cases, a second average porosity on the second surface is larger than the third average porosity.

At least one embodiment of the disclosed technology includes a construction material comprising: (a) a first surface; (b) a second surface substantially opposite of the first surface; (c) one or more walls between and connecting the first surface and the second surface; (d) a body enclosed by the first surface, the second surface and the one or more walls, the body comprises a plurality of aggregate particles; (e) calcium carbonate; and (f) at least one biological organism or enzyme producing at least some of calcium carbonate formed between at least two members of the plurality of aggregate particles, wherein: 1) an average green density of the construction material is from about 1.5 grams per cubic centimeter (g/cc) to about 2.5 g/cc; or 2) an average finished density of the construction material is from about 1.8 g/cc to about 2.7 g/cc; or 3) an average percentage of void of green density is from about 25% to about 46%; or 4) an average percentage of void filled in the finished product (or an average of percentage of CaCO3 made) is from about 5% to about 25%; or 5) any combination thereof.

In some cases, the average green density is from about 1.5 g/cc to about 1.8 g/cc, from about 1.6 g/cc to about 1.9 g/cc, from about 1.7 g/cc to about 2.0 g/cc, from about 1.8 g/cc to about 2.1 g/cc, from about 1.9 g/cc to about 2.2 g/cc, from about 2.0 g/cc to about 2.3 g/cc, or from about 2.1 g/cc to about 2.4 g/cc.

In some cases, the average green density is from about 1.7 gg/cc to about 2.0 g/cc.

In some cases, the average green density is about 1.5, 1.6, 1.7, 1.8, 1.9, 2.0, 2.1, 2.2, 2.3, or 2.4 g/cc.

In some cases, the average finished density is from about 1.8 g/cc to about 1.9 g/cc, from about 1.9 g/cc to about 2.0 g/cc, from about 2.0 g/cc to about 2.1 g/cc, from about 2.1 g/cc to about 2.2 g/cc, from about 2.2 g/cc to about 2.3 g/cc, from about 2.3 g/cc to about 2.4 g/cc, from about 2.4 g/cc to about 2.5 g/cc, from about 2.5 g/cc to about 2.6 g/cc, or from about 2.6 g/cc to about 2.7 g/cc, wherein the finished density is higher than the green density.

In some cases, the average finished density is from about 2.0 g/cc to about 2.1 g/cc.

In some cases, the average finished density is about 1.8, 1.9, 2.0, 2.1, 2.2, 2.3, 2.4, 2.5, 2.6 or 2.7 g/cc.

In some cases, the average percentage of void of green density is from about 25% to about 28%, from about 28% to about 31%, from about 31% to about 34%, from about 34% to about 37%, from about 37% to about 40%, from about 40% to about 43%, or from about 43% to about 46%.

In some cases, the average percentage of void of green density is from about 30% to about 42%.

In some cases, the average percentage of void of green density is about 25%, 26%, 27%, 28%, 29%, 30%, 31%, 32%, 33%, 34%, 35%, 36%, 37%, 38%, 39%, 40%, 31%, 42%, 43%, 44%, 45%, 46%, or 47%.

In some cases, the average of percentage of CaCO3 made is from about 5% to about 10%, from about 10% to about 15%, from about 15% to about 20%, or from about 20% to about 25%.

In some cases, the average of percentage of CaCO3 made is from 10% to about 23%.

In some cases, the average of percentage of CaCO3 made is about 5%, 6%, 7%, 8%, 9%, 10%, 11%, 12%, 13%, 14%, 15%, 16%, 17%, 18%, 19%, 20%, 21%, 22%, 23%, 24%, or 25%.

At least one embodiment of the disclosed technology includes a system for producing a construction material, comprising: (a) a plurality of frameworks, each of the plurality of frameworks comprises: (i) a bottom; (ii) one or more walls, wherein the bottom and the one or more walls together define a space; (iii) an inlet configured to add cementation reagents to the space; and (iv) an outlet configured to remove a mobile phase from the space, wherein the mobile phase comprises depleted cementation reagents; (b) a heat exchange system in thermal communication with the plurality of frameworks; and (c) a controller in communication with the inlet, the outlet, and the heat exchange system, wherein the controller is configured to control a duty cycle of the system, wherein the duty cycle comprises adding the cementation reagents to the space, removing the mobile phase from the space, and keeping a temperature of the bottom higher than a temperature of the cementation reagents in the inlet while adding the cementation reagents.

In some cases, the duty cycle further comprises cooling/heating the bottom and/or the one or more walls after completing adding the cementation reagents.

In some cases, the duty cycle further comprises cooling/heating the inlet during and/or after adding the cementation reagents.

In some cases, the duty cycle further comprises adding air, oxygen or ozone to the space or a top of the space; and/or removing air, oxygen or ozone from the space or the top of the space.

In some cases, the duty cycle further comprises radiating the space using ultraviolet light.

In some cases, the duty cycle further comprises vibrating the plurality of frameworks.

At least one embodiment of the disclosed technology includes a method of producing a construction material, comprising: (a) adding a plurality of aggregate particles and at least one biological organism or enzyme to a framework, thereby forming a framed plurality of aggregate particles comprising at least one surface and a body enclosed by the at least one surface, wherein the at least one biological organism or enzyme resides at least in the body; (b) feeding cementation reagents to the framed plurality of aggregate particles; (c) controlling a first temperature of the body relative to (i) a second temperature of the fed cementation reagents, and/or (ii) a third temperature of a solution phase above the framed plurality of aggregate particles; and (d) forming bridging calcium carbonate crystals between at least two members of the framed plurality of aggregate particles and non-bridging calcium carbonate crystals from starting materials produced by the at least one biological organism or enzyme.

In some cases, the controlling in (c) comprises heating/cooling a bottom of the framework.

In some cases, the controlling in (c) comprises heating the bottom of the framework.

In some cases, the controlling in (c) comprises heating/cooling the fed cementation reagents.

In some cases, the controlling in (c) comprises cooling the fed cementation reagents.

In some cases, the controlling in (c) comprises heating/cooling the solution phase above the framed plurality of aggregate particles.

In some cases, the controlling in (c) comprises cooling the solution phase above the framed plurality of aggregate particles.

In some cases, the method further comprising adding air, oxygen, or ozone to a top of the framework; and/or removing air, oxygen, or ozone from the top of the framework.

In some cases, the method further comprising radiating the framework using ultraviolet light.

In some cases, the method further comprising vibrating the plurality of frameworks.

In some cases, the method further comprising removing a mobile phase from the framework, wherein the mobile phase comprises depleted cementation reagents.

In some cases, the method further comprising controlling a growth time for the at least one biological organism or enzyme in the body before feeding a dose of calcium ion to the framed plurality of aggregate particles.

In some cases, the method further comprising controlling a concentration and/or a feeding rate of a dose of calcium to the framed plurality of aggregate particles.

At least one embodiment of the disclosed technology includes a construction material comprising: a plurality of aggregate particles bound together by one or more cohesive bridges, the cohesive bridges comprising calcium carbonate and at least a trace amounts of a salt comprising an anion selected from the group of Cl⁻, OCN⁻, and CN⁻; wherein a trace amount is determined by detection of at a relative anion intensity of at least 0.005 when measured by an imaging mass spectrometry technique, such as Time of Flight Secondary Ion Mass Spectrometry (Tof-SIMS).

At least one embodiment of the disclosed technology includes a construction material comprising a plurality of aggregate particles bound together by one or more cohesive bridges, the cohesive bridges comprising calcium carbonate and at least one nitrogen containing compound; wherein a ratio of nitrogen to calcium in the cohesive bridges is at least 0.15 (e.g. at least 0.2, 0.3, 0.4, 0.5, or 0.6) when measured by X-ray photoelectron spectroscopy at a surface of the construction material or at a cross-sectional surface of a portion thereof.

At least one embodiment of the disclosed technology includes a cementitious material comprising: (a) calcium; (b) carbonate; and (c) at least 20 ppb of chlorine, cyanide, cyanate, fulminate, and/or combinations of one or more thereof.

At least one embodiment of the disclosed technology includes a cementitious material comprising: (a) calcium; (b) carbonate; and (c) between 10 ppb and 1000 ppb of chlorine, cyanide, cyanate, fulminate, and/or combinations of one or more thereof. In some cases, the cementitious material comprises between 50 ppb and 150 ppb of chlorine, between 150 ppb and 500 ppb of chlorine, or between 500 ppb and 1000 ppb of chlorine. In some cases, the cementitious material comprises between 10 ppb and 20 ppb of cyanide, between 10 ppb and 50 ppb of cyanide, or between 50 ppb and 100 ppb of cyanide, between 50 ppb and 150 ppb of cyanide, between 100 ppb and 200 ppb of cyanide, between 100 ppb and 500 ppb of cyanide, between 200 ppb and 1000 ppb of cyanide, or between 500 ppb and 1000 ppb of cyanide. In some cases, the cementitious material comprises between 10 ppb and 20 ppb of cyanate, between 10 ppb and 50 ppb of cyanate, or between 50 ppb and 100 ppb of cyanate, between 50ppb and 150 ppb of cyanate, between 100 ppb and 200 ppb of cyanate, between 100 ppb and 500 ppb of cyanate, between 200 ppb and 1000 ppb of cyanate, or between 500 ppb and 1000 ppb of cyanate. In some cases, the cementitious material comprises between 10 ppb and 20 ppb of fulminate, between 10 ppb and 50 ppb of fulminate, or between 50 ppb and 100 ppb of fulminate, between 50 ppb and 150 ppb of fulminate, between 100 ppb and 200 ppb of fulminate, between 100 ppb and 500 ppb of fulminate, between 200 ppb and 1000 ppb of fulminate, or between 500 ppb and 1000 ppb of fulminate.

At least one embodiment of the disclosed technology includes a construction material comprising a plurality of aggregate particles bound together by one or more cohesive bridges, the cohesive bridges comprising calcite crystals having an average grain size of about 100 μm or less at a density of at least 10,000 crystals per square centimeter as measured at a surface of the construction material by TEM/SEM.

At least one embodiment of the disclosed technology includes a construction material comprising a plurality of aggregate particles bound together by one or more cohesive bridges, the cohesive bridges comprising calcite crystals having an average grain size of about 100 μm or less at a density of between 5K crystals per square centimeter and 500K crystals per square centimeter as measured at a surface of the construction material by TEM/SEM.

At least one embodiment of the disclosed technology includes a construction material comprising a plurality of aggregate particles bound together by one or more cohesive bridges, the cohesive bridges comprising calcium; and a plurality of pores which are substantially free of solid material; wherein the construction material comprises about 20-50% pores by volume, and the plurality of pores has an average pore diameter of about 1-400 μm (e.g., about 4-275 μm).

At least one embodiment of the disclosed technology includes a first surface; a second surface substantially opposite of the first surface; one or more walls between and connecting the first surface and the second surface; a plurality of aggregate particles enclosed by the first surface, the second surface and the one or more walls; and calcium carbonate, wherein at least some of the calcium carbonate is formed between at least two particles of the plurality of aggregate particles due to biological activity of at least one biological organism or enzyme, and wherein a first average weight of a first portion of the calcium carbonate within a first planar section of the construction material differs no more than 50% of a second average weight of a second portion of the calcium carbonate within a second planar section of the construction material.

The disclosure herein encompasses the subject matter set forth in the following clauses:

Clause 1. A construction material, comprising: a first surface; a second surface substantially opposite of the first surface; one or more walls between and connecting the first surface and the second surface; a plurality of aggregate particles enclosed by the first surface, the second surface and the one or more walls; and calcium carbonate, wherein at least some of the calcium carbonate is formed between at least two particles of the plurality of aggregate particles due to biological activity of at least one biological organism or enzyme, and wherein a first average weight of a first portion of the calcium carbonate within a first planar section of the construction material differs by no more than 50% of a second average weight of a second portion of the calcium carbonate within a second planar section of the construction material.

Clause 2. The construction material of clause 1, wherein: a third portion of the calcium carbonate indirectly structurally connects the at least two particles of the plurality of aggregate particles.

Clause 3. The construction material of clause 1, wherein: the at least some of the calcium carbonate provides a structural connection between the at least two particles of the plurality of aggregate particles.

Clause 4. The construction material of clause 3, wherein: the at least some of the calcium carbonate comprises bridging calcium carbonate.

Clause 5. The construction material of clause 1, wherein: the first average weight of the first portion of the calcium carbonate is less than the second average weight of the second portion of the calcium carbonate.

Clause 6. The construction material of clause 1, wherein: the first planar section abuts a non-preferred surface of the construction material; and the second planar section abuts a preferred surface of the construction material.

Clause 7. The construction material of clause 1, wherein: the first average weight differs by no more than 20% of a third average weight of a third planar section of the construction material arranged between the first planar section and the second planar section.

Clause 8. The construction material of clause 7, wherein: the first average weight is greater than the third average weight.

Clause 17. The construction material of clause 1, wherein: the first planar section abuts the first surface; and the second planar section abuts the second surface.

Clause 18. A construction material, comprising: a first surface; a second surface substantially opposite of the first surface; one or more walls between and connecting the first surface and the second surface; a body including a plurality of aggregate particles, the body enclosed by the first surface, the second surface and the one or more walls; and calcium carbonate, wherein at least some of the calcium carbonate is formed between at least two particles of the plurality of aggregate particles by at least one biological organism or enzyme, and wherein an average dry green density of the construction material is from about 1.52 grams per cubic centimeter (g/cc) to about 2.55 g/cc.

Clause 19. The construction material of clause 18, wherein: an average percentage of void within the construction material is from about 25% to about 46%.

Clause 20. A construction material, comprising: a first surface; a second surface substantially opposite of the first surface; one or more walls between and connecting the first surface and the second surface; a body including a plurality of aggregate particles, the body enclosed by the first surface, the second surface and the one or more walls; and calcium carbonate, wherein at least some of the calcium carbonate is formed between at least two particles of the plurality of aggregate particles by at least one biological organism or enzyme, and wherein an average finished density of the construction material is from about 1.83 grams per cubic centimeter (g/cc) to about 2.72 g/cc.

Clause 21. The construction material of clause 20, wherein: an average percentage of void within the construction material is from about 5% to about 25%.

Clause 25. A method for producing a construction material, comprising: acquiring a plurality of aggregate particles; forming the plurality of aggregate particles; providing a cementation solution that includes a cementation reagent; setting the cementation solution to a first temperature; setting the plurality of aggregate particles to a second temperature different from the first temperature; feeding the cementation solution to the plurality of aggregate particles while the cementation solution is at the first temperature and the plurality of aggregate particles is at the second temperature; and causing a set of bridging calcium carbonate crystals to form between at least two particles of the plurality of aggregate particles subsequent to the cementation solution being applied to the plurality of aggregate particles.

Clause 26. The method of clause 25, further comprising: filtering the cementation solution prior to the feeding the cementation solution to the plurality of aggregate particles.

Clause 27. The method of clause 25, wherein: the first temperature is less than the second temperature.

Clause 31. A method for producing a construction material, comprising: providing a plurality of aggregate particles; pressing the plurality of aggregate particles such that the construction material has an average dry green density from about 1.52 grams per cubic centimeter (g/cc) to about 2.55 g/cc; providing a cementation solution that includes a cementation reagent; applying the cementation solution to the plurality of aggregate particles while the cementation solution is at a first temperature and the plurality of aggregate particles is at a second temperature different from the first temperature; and performing a biocementation process that causes a set of bridging calcium carbonate crystals to form between at least two particles of the plurality of aggregate particles subsequent to the applying the cementation solution to the plurality of aggregate particles.

Clause 32. The method of clause 31, further comprising: outputting the construction material with an average finished density of the construction material from about 1.83 g/cc to about 2.72 g/cc.

Clause 33. The method of any of clause 31-32, wherein: the performing the biocementation process includes causing the set of bridging calcium carbonate crystals to form due to biological activity of at least one biological organism or enzyme.

Clause 37. A method for producing a construction material, comprising: providing a plurality of aggregate particles; forming the plurality of aggregate particles; providing a first filtered cementation solution that includes a cementation reagent; applying the first filtered cementation solution to the plurality of aggregate particles; performing a first biocementation process that causes a first set of bridging calcium carbonate crystals to form between at least two particles of the plurality of aggregate particles; collecting at least a portion of the first filtered cementation solution while applying the first filtered cementation solution to the plurality of aggregate particles; filtering the first filtered cementation solution to produce a second filtered cementation solution; and applying the second filtered cementation solution to the plurality of aggregate particles.

Clause 39. The method of clause 37, wherein: the filtering the first filtered cementation solution to produce the second filtered cementation solution comprises allowing particulate matter within the first filtered cementation solution to settle in a collection tank.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may, in fact, be executed substantially concurrently, or the steps may sometimes be executed in the reverse order, depending upon the functionality involved. In some implementations, steps may be omitted and other steps added without departing from the spirit and scope of the present subject matter.

In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

For purposes of this document, whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

For purposes of this document, whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Some embodiments disclosed herein contemplate numerical ranges. When ranges are present, the ranges include the range endpoints. Additionally, every sub range and value within the range is present as if explicitly written out. The term “about”, “approximately”, or “substantially” may mean within an acceptable error range for the particular value, which may depend in part on how the value is measured or determined, e.g., the limitations of the measurement system. For example, “about” may mean within one or more than one standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A construction material, comprising:
a first surface;
a second surface substantially opposite of the first surface;
one or more walls between and connecting the first surface and the second surface;
a plurality of aggregate particles enclosed by the first surface, the second surface and the one or more walls; and
calcium carbonate,
wherein at least some of the calcium carbonate is formed between at least two particles of the plurality of aggregate particles due to biological activity of at least one biological organism or enzyme, and
wherein a first average weight of a first portion of the calcium carbonate within a first planar section of the construction material differs by no more than 50% of a second average weight of a second portion of the calcium carbonate within a second planar section of the construction material.

2. A construction material, comprising:
a first surface;
a second surface substantially opposite of the first surface;
one or more walls between and connecting the first surface and the second surface;
a body including a plurality of aggregate particles, the body enclosed by the first surface, the second surface and the one or more walls; and
calcium carbonate,
wherein at least some of the calcium carbonate is formed between at least two particles of the plurality of aggregate particles by at least one biological organism or enzyme, and
wherein an average dry green density of the construction material is from about 1.52 grams per cubic centimeter (g/cc) to about 2.55 g/cc.

3. A construction material, comprising:
a first surface;
a second surface substantially opposite of the first surface;
one or more walls between and connecting the first surface and the second surface;
a body including a plurality of aggregate particles, the body enclosed by the first surface, the second surface and the one or more walls; and
calcium carbonate,
wherein at least some of the calcium carbonate is formed between at least two particles of the plurality of aggregate particles by at least one biological organism or enzyme, and
wherein an average finished density of the construction material is from about 1.83 grams per cubic centimeter (g/cc) to about 2.72 g/cc.

4. A construction material, comprising:
a first surface;
a second surface substantially opposite of the first surface;
one or more walls between and connecting the first surface and the second surface;
a plurality of aggregate particles enclosed by the first surface, the second surface and the one or more walls; and
calcium carbonate,
wherein at least some of the calcium carbonate is formed between at least two particles of the plurality of aggregate particles due to biological activity of at least one biological organism or enzyme, and
wherein a first average porosity within a first planar section of the construction material is less than a second average porosity within a second planar section of the construction material prior to the at least some of the calcium carbonate being formed between the at least two particles of the plurality of aggregate particles.

5. A construction material, comprising:
a first surface;
a second surface substantially opposite of the first surface;
one or more walls between and connecting the first surface and the second surface;
a body enclosed by the first surface, the second surface and the one or more walls, the body comprises a plurality of aggregate particles;
calcium carbonate; and
at least one biological organism or enzyme producing at least some of calcium carbonate formed between at least two members of the plurality of aggregate particles, wherein a first average weight percentage of calcium carbonate on the first surface differs no more than 50% of a second average weight percentage of calcium carbonate on the second surface.

6. A method for producing a construction material, comprising:
acquiring a plurality of aggregate particles;
forming the plurality of aggregate particles;
providing a cementation solution that includes a cementation reagent;
setting the cementation solution to a first temperature;
setting the plurality of aggregate particles to a second temperature different from the first temperature;
feeding the cementation solution to the plurality of aggregate particles while the cementation solution is at the first temperature and the plurality of aggregate particles is at the second temperature; and
causing a set of bridging calcium carbonate crystals to form between at least two particles of the plurality of aggregate particles subsequent to the cementation solution being applied to the plurality of aggregate particles.

7. The method of claim 6, further comprising:
filtering the cementation solution prior to the feeding the cementation solution to the plurality of aggregate particles.

8. The method of claim 6, wherein:
the first temperature is less than the second temperature; and
the setting the plurality of aggregate particles to the second temperature includes heating a formwork containing the plurality of aggregate particles to the second temperature.

9. The method of claim 6, further comprising:
setting the plurality of aggregate particles to a third temperature different from the second temperature prior to the causing the set of bridging calcium carbonate crystals to form between the at least two particles of the plurality of aggregate particles.

10. The method of claim 9, wherein:
the third temperature is greater than the second temperature; and
the setting the plurality of aggregate particles to the third temperature includes heating a thermal conductor in physical contact with the plurality of aggregate particles to the third temperature.

11. The method of claim 6, further comprising:
collecting a portion of the cementation solution during the feeding the cementation solution to the plurality of aggregate particles; and
reusing the portion of the cementation solution by reapplying the portion of the cementation solution to the plurality of aggregate particles.

12. A method for producing a construction material, comprising:
providing a plurality of aggregate particles;
pressing the plurality of aggregate particles such that the construction material has an average dry green density from about 1.52 grams per cubic centimeter (g/cc) to about 2.55 g/cc;
providing a cementation solution that includes a cementation reagent;
applying the cementation solution to the plurality of aggregate particles while the cementation solution is at a first temperature and the plurality of aggregate particles is at a second temperature different from the first temperature; and
performing a biocementation process that causes a set of bridging calcium carbonate crystals to form between at least two particles of the plurality of aggregate particles subsequent to the applying the cementation solution to the plurality of aggregate particles.

13. The method of claim 12, further comprising:
outputting the construction material with an average finished density of the construction material from about 1.83 g/cc to about 2.72g/cc.

14. The method of claim 12, wherein:
the average dry green density is from about 1.73 g/cc to about 1.78 g/cc.

15. The method of claim 12, wherein:
the average dry green density is from about 1.80 g/cc to about 2.00 g/cc.

16. The method of claim 12, wherein:
the average dry green density is from about 2.15 g/cc to about 2.20 g/cc.

17. The method of claim 12, wherein:
the performing the biocementation process includes causing the set of bridging calcium carbonate crystals to form due to biological activity of at least one biological organism or enzyme.

18. A method for producing a construction material, comprising:
providing a plurality of aggregate particles;
forming the plurality of aggregate particles;
providing a first filtered cementation solution that includes a cementation reagent;
applying the first filtered cementation solution to the plurality of aggregate particles;
performing a first biocementation process that causes a first set of bridging calcium carbonate crystals to form between at least two particles of the plurality of aggregate particles;
collecting at least a portion of the first filtered cementation solution while applying the first filtered cementation solution to the plurality of aggregate particles;
filtering the first filtered cementation solution to produce a second filtered cementation solution; and
applying the second filtered cementation solution to the plurality of aggregate particles.

19. The method of claim 18, further comprising:
performing a second biocementation process that causes a second set of bridging calcium carbonate crystals to form within the construction material that includes the plurality of aggregate particles.

20. The method of claim 18, wherein:
the filtering the first filtered cementation solution to produce the second filtered cementation solution comprises allowing particulate matter within the first filtered cementation solution to settle in a collection tank.

21. The method of claim 18, further comprising:
setting the first filtered cementation solution to a first temperature; and
setting the plurality of aggregate particles to a second temperature greater than the first temperature, the performing the first biocementation process is performed while the first filtered cementation solution is at the first temperature and the plurality of aggregate particles is at the second temperature.
